(19) United States
(12) Patent Application Publication
(10) Pub. No.: US 2019/0207253 A1
(43) Pub. Date: Jul. 4, 2019

(54) ELECTRODE LAYER MATERIAL, ELECTRODE SHEET FOR ALL-SOLID STATE SECONDARY BATTERY, ALL-SOLID STATE SECONDARY BATTERY, AND METHODS FOR MANUFACTURING ELECTRODE SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Masaomi MAKINO, Ashigarakami-gun (JP); Hiroaki MOCHIZUKI, Ashigarakami-gun (JP); Toshihiko YAWATA, Ashigarakami-gun (JP)

(73) Assignee: FUJIFILM Corporation, Tokyo (JP)

(21) Appl. No.: 16/296,640

(22) Filed: Mar. 8, 2019

Related U.S. Application Data
(63) Continuation of application No. PCT/JP2017/032499, filed on Sep. 8, 2017.

(30) Foreign Application Priority Data
Sep. 12, 2016 (JP) 2016-178010

(51) Int. Cl. H01M 10/0562; H01M 10/058; H01M 4/1315; H01M 4/136; H01M 4/13915; H01M 4/1397; H01M 4/505; H01M 4/525; H01M 4/58; H01M 4/62; H01M 4/66; H01M 10/052

(52) U.S. Cl. CPC H01M 10/0562; H01M 10/058; H01M 4/1315; H01M 4/136; H01M 4/13915; H01M 10/052; H01M 4/505; H01M 4/525; H01M 4/58; H01M 4/621; H01M 4/66; H01M 4/1397

(57) ABSTRACT

Provided are an electrode layer material including a sulfide-based inorganic solid electrolyte (A) having conductivity of an ion of a metal belonging to Group I or II of a periodic table, an organic compound (B), and an active material (C), in which Expression (1) is satisfied, an electrode sheet for an all-solid state secondary battery, and an all-solid state secondary battery.

0.1≤Ec/Ic≤1,000 Expression (1)

In the expression, Ec represents an electron conductivity of the electrode layer material, and Ic represents an ion conductivity of the electrode layer material.

### CROSS-REFERENCE TO RELATED APPLICATIONS

This application is a Continuation of PCT International Application No. PCT/JP2017/032499 filed on Sep. 8, 2017, which claims priority under 35 U.S.C. § 119 (a) to Japanese Patent Application No. 2016-178010 filed in Japan on Sep. 12, 2016. Each of the above applications is hereby expressly incorporated by reference, in its entirety, into the present application.

### BACKGROUND OF THE INVENTION

### 1. Field of the Invention

The present invention relates to an electrode layer material, an electrode sheet for an all-solid state secondary battery, an all-solid state secondary battery, and methods for manufacturing an electrode sheet for an all-solid state secondary battery and an all-solid state secondary battery.

### 2. Description of the Related Art

A lithium ion secondary battery is a storage battery which has a negative electrode, a positive electrode, and an electrolyte sandwiched between the negative electrode and the positive electrode and enables charging and discharging by the reciprocal migration of lithium ions between both electrodes. In the related art, in lithium ion secondary batteries, an organic electrolytic solution has been used as the electrolyte. However, in organic electrolytic solutions, liquid leakage is likely to occur, there is a concern that a short circuit and ignition may be caused in batteries due to overcharging or overdischarging, and there is a demand for additional improvement in safety and reliability.

Under the above-described circumstances, all-solid state secondary batteries in which an inorganic solid electrolyte is used instead of the organic electrolytic solution are attracting attention. In all-solid state secondary batteries, all of the negative electrode, the electrolyte, and the positive electrode are solid, safety and reliability which are considered as a problem of batteries in which the organic electrolytic solution is used can be significantly improved, and it also becomes possible to extend service lives. Furthermore, all-solid state secondary batteries can be provided with a structure in which the electrodes and the electrolyte are directly disposed in series. Therefore, it becomes possible to increase the energy density to be higher than that of secondary batteries in which the organic electrolytic solution is used, and thus the application to electric vehicles, large-sized storage batteries, and the like is anticipated.

Due to the respective advantages described above, as next-generation lithium ion batteries, a development plan of an all-solid state secondary battery is underway (New Energy and Industrial Technology Development Organization (NEDO), Fuel Cell and Hydrogen Technologies Development Department, Electricity Storage Technology Development Section, “NEDO 2013 Roadmap for the Development of Next Generation Automotive Battery Technology” (August, 2013)). As a result of the above-described research, for example, WO2014/002857A discloses an all-solid state battery in which, in a positive electrode layer, the difference between a resistivity attributed to ion migration and a resistivity attributed to electron migration is 0 kΩ·cm or more and 2 kΩ·cm or less for the purpose of providing an all-solid state battery having a large discharge capacity per unit weight and unit volume of a positive electrode active material.

### SUMMARY OF THE INVENTION

In recent years, the development of all-solid state secondary batteries has been rapidly progressing. In association with the progress of the development, a demand for improving the cycle characteristics, the high-rate cycle characteristics, and the storage characteristics (a performance that prevents a decrease in the discharge capacity from the use of an all-solid state secondary battery through the initiation of the reuse) of the all-solid state secondary battery has been intensifying.

In WO2014/002857A, an attempt is made to suppress the progress of an intercalation and deintercalation reaction of lithium ions only in a part of an electrode layer and improve the discharge capacity per unit weight and unit volume of the positive electrode active material by adjusting the difference between the mobility of lithium ions and the mobility of electrons in the electrode layer. However, the attempt is not capable of satisfying all of the above-described three battery performances that have been recently demanded.

In consideration of the above-described circumstances, an object of the present invention is to provide an electrode layer material realizing an all-solid state secondary battery which is not only excellent in terms of the cycle characteristics and the high-rate cycle characteristics but is also excellent in terms of the storage characteristics. In addition, another object of the present invention is to provide an electrode sheet for an all-solid state secondary battery in which the electrode layer material is used. In addition, still another object of the present invention is to provide an all-solid state secondary battery in which the electrode sheet for an all-solid state secondary battery is used. Furthermore, still another object of the present invention is to provide a method for manufacturing an electrode sheet for an all-solid state secondary battery and a method for manufacturing an all-solid state secondary battery in which the electrode layer material is used.

As a result of intensive studies, the present inventors found that, in a case in which the ratio (Ec/Ic) of the electron conductivity Ec of the electrode layer material, to which not only a specific inorganic solid electrolyte and an active material but also an organic compound are added, to the ion conductivity Ic of the electrode layer material is set in a specific range, it is possible to realize an all-solid state secondary battery being excellent in terms of the cycle characteristics, the high-rate cycle characteristics, and the storage characteristics of an all-solid state secondary battery having the electrode layer material. The present invention was completed by repeating additional studies on the basis of the above-described finding.

That is, the above-described objects are achieved by the following means.
<1> An electrode layer material comprising: a sulfide-based inorganic solid electrolyte (A) having conductivity of an ion of a metal belonging to Group I or II of a periodic table; an organic compound (B); and an active material (C), in which Expression (1) is satisfied.

0.1≤Ec/Ic≤1,000 Expression (1)

In the expression, Ec represents an electron conductivity of the electrode layer material, and Ic represents an ion conductivity of the electrode layer material.
<2> The electrode layer material according to <1>, in which the organic compound (B) is a binder and/or a surface modifier.
<3> The electrode layer material according to <2>, in which a content of the binder and/or the surface modifier is 0.001% by mass or more and 10% by mass or less.
<4> The electrode layer material according to <1>, in which the organic compound (B) is a dispersion medium.
<5> The electrode layer material according to <4>, in which a content of the dispersion medium is 0.5% by mass or less.
<6> The electrode layer material according to any one of <1> to <5> which is used as a positive electrode layer.
<7> The electrode layer material according to any one of <1> to <6>, in which Expression (2) is satisfied.

1≤Ec/Ic≤100 Expression (2)
<8> The electrode layer material according to any one of <1> to <7>, in which Ec satisfies 1×10⁻⁵ S/cm≤Ec≤1×10⁻¹ S/cm, and Ic satisfies 1×10⁻⁵ S/cm≤Ic≤1×10⁻² S/cm.
<9> The electrode layer material according to any one of <1> to <8>, in which electron conductivity of the active material (C) is 1×10⁻⁷ S/cm or more and 1×10⁻¹ S/cm or less.
<10> The electrode layer material according to <9>, in which the active material (C) is coated with a conductive coating layer.
<11> The electrode layer material according to <10>, in which the conductive coating layer contains at least one of carbon or a metal oxide.
<12> The electrode layer material according to any one of <1> to <11>, further comprising: a conductive auxiliary agent (D).
<13> The electrode layer material according to <12>, in which the conductive auxiliary agent (D) includes a conductive auxiliary agent having an aspect ratio of 10 or more and a conductive auxiliary agent having an aspect ratio of 3 or less.
<14> The electrode layer material according to any one of <1> to <13>, in which an ion conductivity of the sulfide-based inorganic solid electrolyte (A) is 1×10⁻³ S/cm or more.
<15> An electrode sheet for an all-solid state secondary battery comprising: the electrode layer material according to any one of <1> to <14> on a metal foil.
<16> An all-solid state secondary battery comprising: a positive electrode active material layer; a negative electrode active material layer; and an inorganic solid electrolyte layer, in which at least one layer of the positive electrode active material layer or the negative electrode active material layer is formed of the electrode layer material according to any one of <1> to <14>.
<17> A method for manufacturing the electrode sheet for an all-solid state secondary battery according to <15>, the method comprising: a step of applying a solid electrolyte composition including a sulfide-based inorganic solid electrolyte (A) having conductivity of an ion of a metal belonging to Group I or II of a periodic table, an organic compound (B), and an active material (C).
<18> A method for manufacturing an all-solid state secondary battery comprising: manufacturing an all-solid state secondary battery having the electrode sheet for an all-solid state secondary battery according to <15> through the manufacturing method according to <17>.

In the present specification, “the electrode layer material” refers to a layered material that is used in an active material layer in an all-solid state secondary battery.

In the present specification, numerical ranges expressed using “to” include numerical values before and after the “to” as the lower limit value and the upper limit value.

In the present specification, “acryl” broadly indicates a group of structures having an acryloyl group, and, for example, a structure having a substituent an α position is included in the scope thereof. Here, a structure having a methyl group at the α position is referred to as methacryl, and there are cases in which (meth)acryl or the like is referred to in order to indicate that methacryl is also included in the scope.

The above-described and other characteristics and advantages of the present invention will be further clarified by the following description with appropriate reference to the accompanying drawings.

The electrode layer material of the embodiment of the present invention is capable of realizing an all-solid state secondary battery which is excellent in terms of the cycle characteristics, the high-rate cycle characteristics, and the storage characteristics by being used as at least one layer of a positive electrode active material layer or a negative electrode active material layer in the all-solid state secondary battery. In addition, the electrode sheet for an all-solid state secondary battery of the embodiment of the present invention is capable of realizing an all-solid state secondary battery which is excellent in terms of the cycle characteristics, the high-rate cycle characteristics, and the storage characteristics by having an electrode layer made of an electrode layer material haying the above-described characteristics and being used as an electrode sheet of the all-solid state secondary battery. In addition, the all-solid state secondary battery of the embodiment of the present invention is excellent in terms of the cycle characteristics, the high-rate cycle characteristics, and the storage characteristics. Furthermore, according to the method for manufacturing an electrode sheet for an all-solid state secondary battery and the method for manufacturing an all-solid state secondary battery of the embodiment of the present invention, it is possible to manufacture the electrode sheet for an all-solid state secondary battery and the all-solid state secondary battery of the embodiment of the present invention which have the above-described characteristics.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating a testing device used in examples.

FIG. 3 is an example of measurement results based on an alternating-current impedance method in a method for measuring an ion conductivity and an electron conductivity of an electrode layer material.

FIG. 4 is another example of the measurement results based on the alternating-current impedance method in the method for measuring the ion conductivity and the electron conductivity of the electrode layer material.

### DESCRIPTION OF THE PREFERRED EMBODIMENTS

### Preferred Embodiment

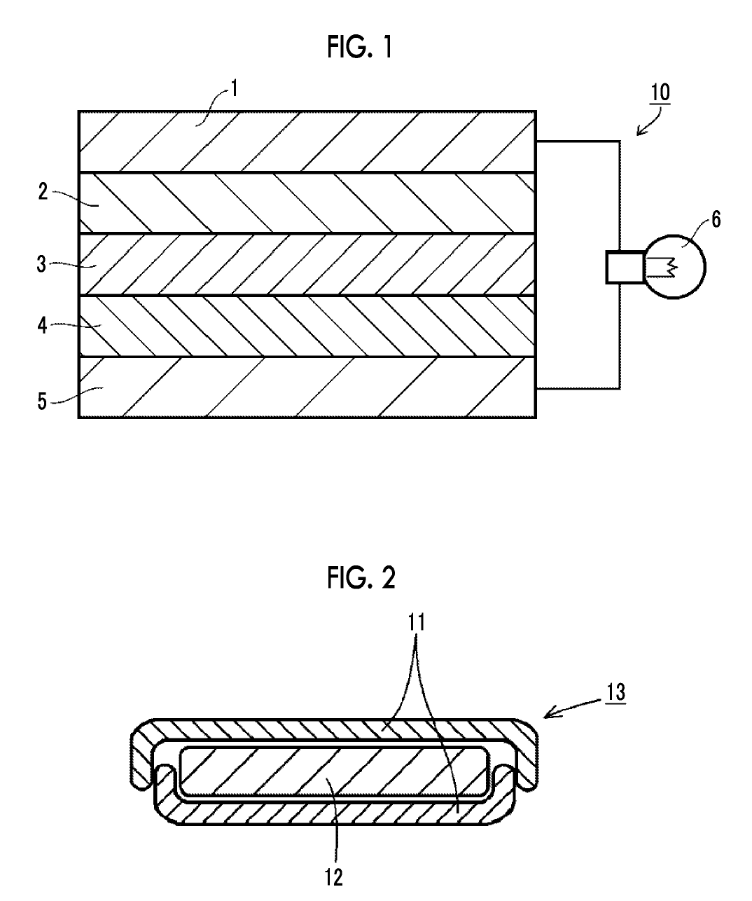

FIG. 1 is a cross-sectional view schematically illustrating an all-solid state secondary battery (lithium ion secondary battery) according to a preferred embodiment of the present invention. In the case of being seen from the negative electrode side, an all-solid state secondary battery 10 of the present embodiment has a negative electrode collector 1, a negative electrode active material layer 2, a solid electrolyte layer 3, a positive electrode active material layer 4, and a positive electrode collector 5 in this order. The respective layers are in contact with one another and have a laminated structure. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated on the negative electrode side return to the positive electrode, and electrons are supplied to an operation portion 6. In an example illustrated in the drawing, an electric bulb is employed as the operation portion 6 and is tit by discharging. Hereinafter, an all-solid state secondary battery having a layer constitution of FIG. 1 will also be referred to as the all-solid state secondary battery sheet in some cases.

An electrode layer material according to the embodiment of the present invention is preferably used as the negative electrode active material layer or the positive electrode active material layer.

In the present specification, the positive e active material layer (hereinafter also referred to as the positive electrode layer) and the negative electrode active material layer (hereinafter, also referred to as the negative electrode layer) will be collectively referred to as the electrode layer or the active material layer in some cases.

The thicknesses of the positive electrode active material layer 4, the solid electrolyte layer 3, and the negative electrode active material layer 2 are not particularly limited. Meanwhile, in a case in which the dimensions of ordinary batteries are taken into account, the thicknesses are preferably 10 to 1,000 μm and more preferably 20 μm or more and less than 500 μm. In the all-solid state secondary battery of the embodiment of the present invention, the thickness of at least one layer of the positive electrode active material layer 4, the solid electrolyte layer 3, or the negative electrode active material layer 2 is still more preferably 50 μm or more and less than 500 μm.

### Electrode Layer Material

The electrode layer material of the embodiment of the present invention includes a sulfide-based inorganic solid electrolyte (A) having conductivity of an ion of a metal belonging to Group I or II of a periodic table, an organic compound (B), and an active material (C) and satisfies Expression (1).

0.1≤Ec/Ic≤1,000 Expression (1)

In the expression, Ec represents an electron conductivity of the electrode layer material, and Ic represents an ion conductivity of the electrode layer material.

In a case in which Ec/Ic is less than 0.1, the efficient use of all active materials is not possible, and it is difficult to extract the capacity as battery-planed. In a case in which Ec/Ic exceeds 1,000, an electrochemical side reaction of an undesired organic compound is likely to be caused, and thus, particularly, the battery characteristics in a test at a high rate deteriorate.

Hereinafter, there will be cases in which components that are contained or can be contained in a solid electrolyte composition of the present invention will be mentioned without any references like, for example, “the inorganic solid electrolyte (A)” being mentioned as “the inorganic solid electrolyte”.

### (Inorganic Solid Electrolyte)

The inorganic solid electrolyte is an inorganic solid electrolyte, and the solid electrolyte refers to a solid-form electrolyte capable of migrating ions therein. The inorganic solid electrolyte is clearly differentiated from organic solid electrolytes (polymer electrolytes represented by polyethylene oxide (PEO) or the like and organic electrolyte salts represented by lithium bis(trifluoromethanesulfonyl)imide (LiTFSI)) since the inorganic solid electrolyte does not include any organic substances as a principal ion-conductive material. In addition, the inorganic solid electrolyte is a solid in a static state and is thus, generally, not disassociated or liberated into rations and anions. Due to this fact, the inorganic solid electrolyte is also clearly differentiated from inorganic electrolyte salts of which cations and anions are disassociated or liberated in electrolytic solutions or polymers (LiPF₆, LiBF₄, LiFSI, LiCl, and the like). The inorganic solid electrolyte is not particularly limited as long as the inorganic solid electrolyte has conductivity of an ion of a metal belonging to Group I or II of the periodic table and is generally a substance not having electron conductivity.

In the present invention, the inorganic solid electrolyte has conductivity of an ion of a metal belonging to Group I or II of the periodic table. As the inorganic solid electrolyte, it is possible to appropriately select and use solid electrolyte materials that are applied to this kind of products. Typical examples of the inorganic solid electrolyte include (i) sulfide-based inorganic solid electrolytes and (ii) oxide-based inorganic solid electrolytes. In the present invention, the sulfide-based inorganic solid electrolytes (preferably Li—P—S-based glass described below) are used since it is possible to form a more favorable interface between the active material and the inorganic solid electrolyte. Hereinafter, the sulfide-based inorganic solid electrolytes will be described.

### (Sulfide-Based Inorganic Solid Electrolytes (A))

Sulfide-based inorganic solid electrolytes are preferably compounds which contain sulfur atoms (S), have an ion conductivity of a metal belonging to Group I or II of the periodic table, and have electron-insulating properties. The sulfide-based inorganic solid electrolytes are preferably inorganic solid electrolytes which, as elements, contain at least Li, S, or P and have a lithium ion conductivity, but the sulfide-based inorganic solid electrolytes may also include elements other than Li, S, and P depending on the purposes or cases.

Examples thereof include lithium ion-conductive inorganic solid electrolytes satisfying a composition represented by Formula (I).

Lₐ₁M_{b1}P_{c1}S_{d1}A_{c1} Formula (I)

In the formula, I, represents an element selected from Li, Na, and K and is preferably Li. M represents an element selected from B, Zn, Sn, Si, Cu, Ga, Sb, Al, and Ge. A represents an element selected from 1, Br, Cl, and F. a1 to e1 represent the compositional ratios among the respective elements, and a1:b1:c1:d1:e1 satisfies 1 to 12:0 to 5:1:2 to 12:0 to 10. Furthermore, a1 is preferably 1 to 9 and more preferably 1.5 to 7.5. b1 is preferably 0 to 3. Furthermore, d1 is preferably 2.5 to 10 and more preferably 3.0 to 8.5. Furthermore, e1 is preferably 0 to 5 and more preferably 0 to 3.

The compositional ratios among the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio between Li₂S and P₂S₅ in Li—P—S-based glass and Li—P—S-based glass ceramic is preferably 60:40 to 90:10 and more preferably 68:32 to 78:22 in terms of the molar ratio between Li₂S:P₂S₅. In a case in which the ratio between Li₂S and P₂S₅ is set in the above-described range, it is possible to increase the lithium ion conductivity.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—GA₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅LiI, Li₂S—SiS₂—LiI, Li₂S—SiS₂—Li₄SiO₄, Li₂S—SiS₂—Li₃PO₄, Li₁₀GeP₂S₁₂, and the like. Mixing ratios of the respective raw materials do not matter. Examples of a method for synthesizing sulfide-based inorganic solid electrolyte materials using the above-described raw material compositions include an amorphization method. Examples of the amorphization method include a mechanical milling method, a solution method, and a melting quenching method. This is because treatments at normal temperature become possible, and it is possible to simplify manufacturing steps.

The ion conductivity of the sulfide-based inorganic solid electrolyte (A) is preferably 1×10⁻⁴ S (siemens)/cm or more and more preferably 1×10⁻³ S/cm or more since it is possible to more efficiently conduct lithium ions in the presence of the organic compound from the collector to the surface layer of the active material layer with no delay. The upper limit is not particularly limited, but is realistically 1×10⁻¹ S/cm or less.

The ion conductivity of the sulfide-based inorganic solid electrolyte (A) that is used in the present invention can be measured with reference to a measurement method described in the section of examples.

The volume-average particle diameter of the sulfide-based inorganic solid electrolyte is not particularly limited, but is preferably 0.01 μm or more and more preferably 0.1 μm or more. The upper limit is preferably 100 μm or less and more preferably 50 μm or less. Meanwhile, the average particle diameter of inorganic solid electrolyte particles is measured in the following order. A dispersion liquid of 1% by mass of the inorganic solid electrolyte particles is prepared using water (heptane in a case in which a substance is unstable in water) in a 20 ml sample bottle. This dispersed specimen (the dispersion liquid) is irradiated with 1 kHz ultrasonic waves for 10 minutes and then immediately used for testing. Data capturing is carried out 50 times using this dispersion liquid specimen, a laser diffraction/scattering-type particle size distribution measurement instrument LA-920 (trade name, manufactured by Horiba Ltd.), and a silica cell for measurement at a temperature of 25° C., thereby obtaining the volume-average particle diameter. Regarding other detailed conditions and the like, the description of JIS Z8828:2013 “Particle size analysis-Dynamic light scattering methods” is referred to as necessary. Five specimens are produced. and measured per level, and the average values thereof are employed.

In a case in which a decrease in the interface resistance and the maintenance of the decreased interface resistance in the case of being used in the all-solid state secondary battery are taken into account, the content of the sulfide-based inorganic solid electrolyte in the solid component of the electrode layer material is preferably 5% by mass or more, more preferably 10% by mass or more, and particularly preferably 20% by mass or more with respect to 100% by mass of the solid components. From the same viewpoint, the upper limit is preferably 99.9% by mass or less, more preferably 99.5% by mass or less, and particularly preferably 99% by mass or less.

These sulfide-based inorganic solid electrolytes may be used singly or two or more sulfide-based inorganic solid electrolytes may be used in combination.

Meanwhile, the solid content in the present specification refers to a component that does not volatilize or evaporate and thus disappear in the case of being subjected to a drying treatment in a nitrogen atmosphere at 170° C. for six hours. Typically, the solid content refers to a component other than a dispersion medium described below.

### (Organic Compound (B))

The electrode layer material of the embodiment of e present invention contains an organic compound since the electrode layer material is capable of improving the dispersibility of additives such as an active material, an inorganic solid electrolyte, and a conductive auxiliary agent and capable of following a volume change in the electrode layer material caused by the expansion and shrinkage of the active material. In addition, in the electrode layer material to which the organic compound is added, it is considered that the organic compound is interposed between the active material and/or the inorganic solid electrolyte due to the interaction and the active material is present in a well-dispersed manner. In order to exhibit more favorable high-rate cycle characteristics and more favorable storage characteristics, it is necessary to effectively use the active material, and, in an electrode in which the active material is favorably dispersed, it is considered that the performance is dependent on the ion conduction and the electron conduction from the surface layer to the inside of the active material. In a case in which the ratio between the ion conductivity and the electron conductivity is in a specific range, it is possible to favorably use even the inside of the active material, and thus it is considered that an excellent performance is exhibited.

The organic compound that is used in the present invention is not particularly limited, but an organic compound functioning as a binder, a surface modifier, or a dispersion medium is preferred.

—Binder—

The electrode layer material of the embodiment of the present invention preferably contains a binder since the binding property between solid particles and between the respective layers constituting the all-solid state secondary battery improves.

The binder that is used in the electrode layer material of the embodiment of the present invention is not particularly limited as long as the binder is an organic polymer.

Binders that can be used in the present invention are not particularly limited, and, for example, binders made of a resin described below are preferred.

Examples of fluorine-containing resins include polytetrafluoroethylene (PTFE), polyvinylene difluoride (PVdF), and copolymer of polyvinylene difluoride and hexafluoropropylene (PVdF-HFP).

Examples of hydrocarbon-based thermoplastic resins include polyethylene, polypropylene, styrene butadiene rubber (SBR), hydrogenated styrene butadiene rubber (HSBR), butylene rubber, acrylonitrile butadiene rubber, polybutadiene, and polyisoprene.

Examples of acrylic resins include a variety of (meth)acrylic monomers, (meth)acrylamide monomers, and copolymers of monomers constituting these resins.

In addition, copolymers with other vinyl-based monomers are also preferably used. Examples thereof include copolymers of polymethyl (meth)acrylate and polystyrene, copolymers of polymethyl (meth)acrylate and acrylonitrile, and copolymers of polybutyl (meth)acrylate, acrylonitrile, and styrene.

Examples of other resins include a polyurethane resin, a polyurea resin, a polyamide resin, a polyimide resin, a polyester resin, a polyether resin, a polycarbonate resin, a cellulose derivative resin, and the like.

These binders may be used singly or two or more binders may be used in combination.

The shape of the binder is not particularly limited and may be a particle shape or an irregular shape in the all-solid state secondary battery.

The moisture concentration of the polymer constituting the binder that is used in the present invention is preferably 100 ppm (mass-based) or less.

In addition, the polymer constituting the binder that is used in the present invention may be used in a solid state or may be used in a state of a polymer particle dispersion liquid or a polymer solution in the case of forming the electrode layer material.

The mass average molecular weight of the polymer constituting the binder that is used in the present invention is preferably 10,000 or more, more preferably 20,000 or more, and still more preferably 30,000 or more. The upper limit is preferably 1,000,000 or less, more preferably 200,000 or less, and still more preferably 100,000 or less.

—Measurement of Molecular Weight—

Unless particularly otherwise described, the molecular weight of the binder in the present invention refers to the mass average molecular weight, and the standard polystyrene-equivalent mass average molecular weight is measured by means of gel permeation chromatography (GPC). Regarding the measurement method, basically, a value measured using a method under the following condition 1 or condition 2 (preferential) is used. Here, an appropriate eluent may be appropriately selected and used depending on the kind of the binder.

### (Condition 1)

Column: Two TOSOH TSKgel Super AWM-H (trade name) are connected together
Carrier: 10 mM LiBr/N-methylpyrrolidone
Measurement temperature: 40° C.
Carrier flow rate: 1.0 mL/min
Specimen concentration: 0.1% by mass
Detector: Refractive index (RI) detector

### (Condition 2) Preferential

Column: A column obtained by connecting TOSOH TSKgel Super HZM-H (trade name), TOSOH TSKgel Super HZ4000 (trade name), and TOSOH TSKgel Super HZ 2000 (trade name) is used.
Carrier: Tetrahydrofuran
Measurement temperature: 40° C.
Carrier flow rate: 1.0 mL/min
Specimen concentration: 0.1% by mass
Detector: Refractive index (RI) detector

—Surface Modifier—

In a case in which a surface modifier is added to a solid electrolyte composition for forming, the electrode layer material of the embodiment of the present invention (hereinafter, referred to as a composition for an electrode (a composition for a positive electrode or a composition for a negative electrode) of the present invention), it is possible to suppress the agglomeration of the active material or the inorganic solid electrolyte even in a case in which the content of any of the active material or the inorganic solid electrolyte is great. As a result, in a case in which the electrode layer material of the embodiment of the present invention contains a surface modifier, the distributions of the active material and the inorganic solid electrolyte in the electrode layer material become uniform, and an effect of improving the output of the all-solid state secondary battery is exhibited.

The surface modifier is preferably made of a small molecule or oligomer having a molecular weight of 200 or more and less than 3,000 and contains at least one functional group represented by the following group of functional groups (I) and an alkyl group having 8 or more carbon atoms or an aryl group having 10 or more carbon atoms in the same molecule.

Group of functional groups (1): an acidic group, a group having a basic nitrogen atom, a (meth)acryloyloxy group, a (meth)acryloylamino group, an alkoxysilyl group (preferably having 1 to 8 carbon atoms), an epoxy group, an oxetanyl group, an isocyanate group, a cyano group, a sulfanyl group, and a hydroxy group

The molecular weight of the surface modifier is more preferably 3010 or more and less than 2,000 and particularly preferably 500 or more and less than 1,000. In a case in which the molecular weight is in the above-described range, it is possible to effectively suppress the agglomeration of solid particles and further improve the output of the all-solid state secondary battery. Meanwhile, in the case of a particle dispersant not having a single molecular weight, the mass average molecular weight is preferably in the above-described range. The mass average molecular weight of the particle dispersant can be computed in the same manner as the mass average molecular weight of the binder.

Specific examples of the acidic group include a carboxy group, a hydroxy group, a sulfanyl group, a —N(R)—COOH group (R represents a hydrogen atom, an alkyl group, or an aryl group), a sulfonic acid group, and a phosphoric acid group, and a carboxy group is preferred.

Specific examples of the group having a basic nitrogen atom include an amino (—NR₂) group, an amide (—CONR₂) group, a sulfonamide group, and a phosphoric acid amide group, and an amino group and an amide group are preferred, Meanwhile, R in the amino group and the amide group is identical to R in the —N(R)—COON group.

In the group of functional groups (I), a group selected from the acidic group, the group having a basic nitrogen atom, and the cyano group is preferred, and an acidic group is particularly preferred.

The surface modifier has an alkyl group having 8 or more carbon atoms or an aryl group having 10 or more carbon atoms.

The alkyl group having 8 or more carbon atoms needs to be an alkyl group having 8 or more carbon atoms in total, may have a linear shape, a branched shape, or a cyclic shape, is not limited to the case of a hydrocarbon, and may also contain a hetero atom between carbon-carbon bonds, in addition, the alkyl group having 8 or more carbon atoms may be unsubstituted or may further have a substituent, and, in a case in which the alkyl group has a substituent, the substituent is preferably a halogen atom. The alkyl group may have a carbon-carbon unsaturated bond in an alkyl chain.

As the halogen atom, a fluorine atom, a chlorine atom, a bromine atom, an iodine atom, and the like are exemplified, and a fluorine atom is preferred.

The alkyl group having 8 or more carbon atoms is preferably an alkyl group having or more and 50 or less carbon atoms, more preferably an alkyl group having 8 or more and 30 or less carbon atoms, still more preferably an alkyl group having 8 or more and 20 or less carbon atoms, and particularly preferably an alkyl group having 8 or more and 18 or less carbon atoms.

Specifically, a normal octyl group, a normal decyl group, a normal dodecyl group, a normal tetradecyl group, a normal hexadecyl group, a stearyl group, a lauryl group, a linole group (a monovalent group in which one hydrogen atom is desorbed from a terminal methyl group of linoleic acid), a linolen group (a monovalent group in which one hydrogen atom is desorbed from a terminal methyl group of an α- or γ-linolenic acid), a 2-ethylhexyl group, a 2-ethyloctyl group, a 2-ethyldodecyl group, a polyethylene glycol monomethyl group, a perfluorooctyl group, a perfluorododecyl group, and the like are exemplified.

Among these, a normal octyl group, a 2-ethylhexyl group, a normal nonyl group, a normal decyl group, a normal undecyl group, a normal dodecyl group, a normal tetradecyl group, and a normal octadecyl group (a stearyl group) are preferred.

In a case in which the alkyl group having 8 or more carbon atoms has a substituent, examples of the substituent include an aryl group having 6 or more carbon atoms such as a phenyl group or a naphthyl group, a halogen atom, and the like. For example, the alkyl group may be an alkyl group substituted with an aryl group or an alkyl halide group substituted with halogen.

The aryl group having 10 or more carbon atoms needs to be an aryl group having 10 or more carbon atoms in total, is not limited to the case of a hydrocarbon, and may also contain a hetero atom between carbon-carbon bonds. In addition, the aryl group having 10 or more carbon atoms may be unsubstituted or may further have a substituent, and, in a case in which the aryl group has a substituent, the substituent is preferably a halogen atom.

The aryl group having 10 or more carbon atoms is preferably an aryl group having 10 or more and 50 or less carbon atoms, more preferably an aryl group having 10 or more and 30 or less carbon atoms, still more preferably an aryl group having 10 or more and 20 or less carbon atoms, and particularly preferably an aryl group having 10 or more and 18 or less carbon atoms.

Specifically, a naphthyl group, an anthracenyl group, a pyrenyl group, a terphenyl group, a naphthacenyl group, a pentacenyl group, a benzopyrenyl group, a chrysenyl group, a triphenylenyl group, a colrannirenyl group, a coronenyl group, an ovalenyl group, and the like are exemplified.

Among these, a condensed aromatic hydrocarbon group is preferred.

In a case in which the aryl group having 10 or more carbon atoms has a substituent, examples of the substituent include an alkyl group having 8 or more carbon atoms such as a normal octyl group, a halogen atom, and the like. For example, the aryl group may be an aryl group substituted with an alkyl group.

The most preferred combination is a combination having a carboxy group and an alkyl group having 8 or more carbon atoms in the same molecule, and, specifically, a long-chain saturated fatty acid and a long-chain unsaturated fatty acid can be more preferably used.

The surface modifier more preferably has two or more groups represented by the group of functional groups (I) and two or more alkyl groups having 8 or more carbon atoms or two or more aryl groups having 10 or more carbon atoms in the same molecule.

The content of the binder and/or the surface modifier in the electrode layer material of the embodiment of the present invention is preferably 0.001% by mass or more and 10% by mass or less, more preferably 0.005% by mass or more and 5% by mass or less, and particularly preferably 0.01% by mass or more and 3% by mass or less in total. This is considered to be because, in a case in which the content of the binder and/or the surface modifier is in the above-described range, the inorganic solid electrolyte and the active material are favorably dispersed and the organic compound does not have any influence on an increase in the battery resistance.

### (Dispersion Medium)

The electrode layer material of the embodiment of the present invention also preferably contains a dispersion medium used to produce the electrode layer material (which remains in the electrode layer material) since the dispersion medium is interposed between the active materials, between the inorganic solid electrolyte and the inorganic solid electrolyte, and between the active material and the inorganic solid electrolyte and is capable of suppressing agglomeration. Specific examples of the dispersion medium include dispersion media described below.

Examples of an alcohol compound solvent include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

As an ether compound solvent, alkylene glycol alkyl ether, ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, propylene glycol dimethyl ether, dipropylene glycol monomethyl ether, dipropylene glycol monomethyl ether, diethylene glycol monobutyl ether, diethylene glycol dibutyl ether, and the like, dialkyl ethers (dimethyl ether, diethyl ether, diisopropyl ether, dibutyl ether, and the like), alkylaryl ether (anisole), tetrahydrofuran, dioxane (including each of 1,2-, 1,3-, and 1,4-isomers), t-butyl methyl ether, and cyclohexyl methyl ether.

Examples of an amide compound solvent include N,N-dimethylformamide, 1-methyl-2-pyrrolidone, 2-pyrrolidinone, 1,3-dimethyl-2-imidazolidinone, ϵ-caprolactam, formamide, N-methylformamide, acetamide, N-methylacetamide, N,N-dimethylacetamide, N-methylpropanamide, and hexamethylphosphoric triamide.

Examples of an amino compound solvent include triethylamine, diisopropylethylamine, and tributylamine.

Examples of a ketone compound solvent include acetone, methyl ethyl ketone, methyl isobutyl ketone, and cyclohexanone.

Examples of an aromatic compound solvent include benzene, toluene, xylene, and mesitylene.

Examples of an aliphatic compound solvent include hexane, heptane, cyclohexane, methylcyclohexane, octane, pentane, and cyclopentane.

Examples of a nitrile compound solvent include acetonitrile, propionitrile, and butyronitrile.

The boiling point of the dispersion medium at a normal pressure (1 atmosphere) is preferably 50° C. or higher and more preferably 70° C. or higher. The upper limit is preferably 250° C. or lower and more preferably 220° C. or lower. The dispersion medium may be used singly or two or more dispersion media may be used in combination.

In the present invention, among them, an aliphatic compound solvent, an ether compound solvent, and a ketone-based solvent are preferred, an ether compound solvent is more preferred, and tetrahydrofuran and dibutyl ether are particularly preferred.

The content of the dispersion media in the electrode layer material of the embodiment of the present invention is preferably 0.5% by mass or less and more preferably 0.2% by mass or less in total. The lower limit value is preferably 0.001% by mass or more and more preferably 0.01% by mass or more. This is because, in a case in which content of the dispersion medium is in the above-described range, it is possible to exhibit a favorable dispersion performance and a favorable battery performance without deteriorating the battery performance.

The content of the dispersion medium the electrode layer material of the embodiment of the present invention can be measured using the following method.

A 20 mm×20 mm specimen is cut out from the electrode layer material by punching and immersed in heavy tetrahydrofuran in a glass bottle. The obtained eluted substance is filtered using a syringe filter, and a quantitative operation by ¹H-NMR is carried out. The correlation between the ¹H-NMR peak surface area and the amount of a solvent is obtained by producing a calibration curve.

In the electrode layer material of the embodiment of the present invention, the organic compound may be used singly or two or more organic compound may be used in combination.

### (Active Material (C))

The electrode layer material of the embodiment of the present invention contains an active material capable of inserting and discharging an ion of a metal element belonging to Group I or II of the periodic table. As the active material, a positive electrode active material and a negative electrode active material are exemplified, and a transition metal oxide that is a positive electrode active material, graphite that is a negative electrode active material, amorphous carbon, and a metal oxide are preferred.

In the present invention, the electron conductivity of the active material (C) is preferably 1×10⁻⁷ S/cm or more and 1×10⁻¹ S/cm or less, more preferably 1×10⁻⁶ S/cm or more and 9×10⁻² S/cm or less, and particularly preferably 1×10⁻⁵ S/cm or more and 8×10⁻² S/cm or less since it is possible to efficiently conduct a current from the collector to the active material.

—Positive Electrode Active Material—

A positive electrode active material that is used in the present invention may contain is preferably a positive electrode active material capable of reversibly inserting and discharging lithium ions. The above-described material is not particularly limited as long as the material has the above-described characteristics and may be transition metal oxides, organic substances, elements capable of being complexed with Li such as sulfur, complexes of sulfur and metal, or the like.

Among these, as the positive electrode active material, transition metal oxides are preferably used, and transition metal oxides having a transition metal element M^{a} (one or more elements selected from Co, Ni, Fe, Mn, Cu, and V) are more preferred. In addition, an element M^{b} (an element of Group I (Ia) of the metal periodic table other than lithium, an element of Group II (IIa), or an element such as Al, Ga, In, Ge, Sn, Pb, Sb, Bi, Si, P, or B) may be mixed into this transition metal oxide. The amount of the element mixed is preferably 0 to 30 mol % of the amount (100 mol %) of the transition metal element M^{a}. The positive electrode active material is more preferably synthesized by mixing the element into the transition metal oxide so that the molar ratio of Li/M^{a} reaches 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), lithium-containing transition metal silicate compounds (ME), and the like.

Specific examples of the transition metal oxides having a bedded salt-type structure (MA) include LiCoO₂ (lithium cobalt oxide [LCO]), LiNiO₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compounds (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and monoclinic nasicon-type vanadium phosphate salt such as Li₃V₂(PO₄)₃ (lithium vanadium phosphate).

Examples of the lithium-containing transition metal halogenated phosphoric acid compounds (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, Li₂CoSiO₄, and the like.

In the present invention, the transition metal oxides having a bedded salt-type structure (MA) is preferred, and NCA, LCO, or NMC is more preferred.

The shape of the positive electrode active material is not particularly limited, but is preferably a particle shape. The volume-average particle diameter (circle-equivalent average particle diameter) of positive electrode active material particles is not particularly limited. For example, the volume-average particle diameter can be set to 0.1 to 50 μm. In order to provide a predetermined particle diameter to the positive electrode active material, an ordinary crusher or classifier may be used. Positive electrode active materials obtained using a firing method may be used after being washed with water, an acidic aqueous solution, an alkaline aqueous solution, or an organic solvent. The volume-average particle diameter (circle-equivalent average particle diameter) of positive electrode active material particles can be measured using a laser diffraction/scattering-type particle size distribution measurement instrument LA-920 (trade name, manufactured by Horiba Ltd.).

The positive electrode active material may be used singly or two or more positive electrode active materials may be used in combination.

In the case of forming a positive electrode active material layer, the mass (mg) of the positive electrode active material per unit area (cm²) of the positive electrode active material layer (weight per unit area) is not particularly limited and can be appropriately determined depending on the set battery capacity.

The content of the positive electrode active material in the electrode layer material is not particularly limited, but is preferably 10% to 95% by mass, more preferably 30% to 90% by mass, still more preferably 50% to 85% by mass, and particularly preferably 55% to 80% by mass with respect to a solid component of 100% by mass.

—Negative Electrode Active Material—

A negative electrode active material that is used in the present invention may contain is preferably a negative electrode active material capable of reversibly inserting and discharging lithium ions. The above-described material is not particularly limited as long as the material has the above-described characteristics, and examples thereof include carbonaceous materials, metal oxides such as tin oxide, silicon oxide, metal complex oxides, a lithium single body, lithium alloys such as lithium aluminum alloys, metals capable of forming alloys with lithium such as Sn, Si, Al and In and the like. Among these, carbonaceous materials or metal complex oxides are preferably used in terms of reliability. In addition, the metal complex oxides are preferably capable of absorbing and discharging lithium. The materials are not particularly limited, but preferably contain titanium and/or lithium as constituent components from the viewpoint of high-current density charging and discharging characteristics.

The carbonaceous material that is used as the negative electrode active material is a material substantially consisting of carbon. Examples thereof include petroleum pitch, carbon black such as acetylene black (AB), hard carbon, graphite (natural graphite, artificial graphite such as highly oriented pyrolytic graphite), and carbonaceous material obtained by firing a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, glassy carbon fibers, and active carbon fibers, mesophase microspheres, graphite whisker, flat graphite, and the like.

In the present invention, hard carbon and graphite are preferred, and graphite is more preferred.

The metal oxides and the metal complex oxides being applied as the negative electrode active material are particularly preferably amorphous oxides, and furthermore, chalcogenides which are reaction products between a metal element and an element belonging to Group XVI of the periodic table are also preferably used. The amorphous oxides mentioned herein refer to oxides having a broad scattering band having a peak of a 2θ value in a range of 20° to 40° in an X-ray diffraction method in which CuKα rays are used and may have crystalline diffraction lines.

In a compound group consisting of the amorphous oxides and the chalcogenides, amorphous oxides of semimetal elements and chalcogenides are more preferred, and elements belonging to Groups XIII (IIIB) to XV (VB) of the periodic table, oxides consisting of one element or a combination of two or more elements of Al, Ga, Si, Sn, Ge, Pb, Sb, and Bi, and chalcogenides are particularly preferred. Specific examples of preferred amorphous oxides and chalcogenides include, for example, Ga₂O₃, SiO, GeO, SnO, SnO₂, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Bi₂O₄, SnSiO₃, GeS, SnS, SnS₂, PbS, PbS₂, Sb₂S₃, Sb₂S₅, and SnSiS₃. In addition, these amorphous oxides may be complex oxides with lithium oxide, for example, Li₂SnO₂.

The negative electrode active material preferably contains a titanium atom. More specifically, Li₄Ti₅O₁₂ (lithium titanium oxide [LTO]) is preferred since the volume fluctuation during the absorption and discharge of lithium ions is small, and thus the high-speed charging and discharging characteristics are excellent, and the deterioration of electrodes is suppressed, whereby it becomes possible to improve the service lives of lithium ion secondary batteries.

In the present invention, a Si-based negative electrode is also preferably applied. Generally, a Si negative electrode is capable of absorbing a larger number of Li ions than a carbon negative electrode (graphite, acetylene black, or the like). That is, the amount of Li ions absorbed per unit mass increases. Therefore, it is possible to increase the battery capacity. As a result, there is an advantage that the battery driving duration can be extended.

The shape of the negative electrode active material is not particularly limited, but is preferably a particle shape. The average particle diameter of the negative electrode active material is preferably 0.1 to 60 μm. In order to provide a predetermined particle diameter, an ordinary crusher or classifier is used. For example, a mortar, a ball mill, a sand mill, an oscillatory ball mill, a satellite ball mill, a planetary ball mill, a swirling airflow-type jet mill, a sieve, or the like is preferably used. During crushing, it is also possible to carry out wet-type crushing in which water or an organic solvent such as methanol is made to coexist as necessary. In order to provide a desired particle diameter, classification is preferably carried out. The classification method is not particularly limited, and it is possible to use a sieve, a wind power classifier, or the like depending on the necessity. Both of dry-type classification and wet-type classification can be carried out. The average particle diameter of negative electrode active material particles can be measured using the same method as the method for measuring the volume-average particle diameter of the positive electrode active material.

The chemical formulae of the compounds obtained using a firing method can be computed using an inductively coupled plasma (ICP) emission spectroscopic analysis method as a measurement method front the mass difference of powder before and after firing as a convenient method.

The negative electrode active material may be used singly or two or more negative electrode active materials may be used in combination.

In the case of forming a negative electrode active material layer, the mass (mg) of the negative electrode active material per unit area (cm²) in the negative electrode active material layer (weight per unit area) is not particularly limited and can be appropriately determined depending on the set battery capacity.

The content of the negative electrode active material in the solid electrolyte composition is not particularly limited, but is preferably 10% to 80% by mass and more preferably 20% to 80% by mass with respect to a solid component of 100% by mass.

The surfaces of the positive electrode active material and the negative electrode active material may be coated with a separate metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, lithium niobite-based compounds, and the like, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, B₂O₃, and the like.

In addition, a surface treatment may be carried out on the surfaces of electrodes including the positive electrode active material or the negative electrode active material using sulfur, phosphorous, or the like.

Furthermore, the particle surfaces of the positive electrode active material or the negative electrode active material may be treated with an actinic ray or an active gas (plasma or the like) before or after the coating of the surfaces.

The active material that is used in the present invention is preferably coated with a conductive coating layer in order to improve the electron conductivity of the active material and improve the electron conductivity of the electrode. Hereinafter, the active material coated with a conductive coating layer will also be referred to as the coated active material.

In the present specification, “the surface being coated with a conductive coating layer” means that at least a part of the surface of the active material is coated and all or part of the surface of the active material may be uniformly or unevenly coated as long as the effect of the present invention is exhibited.

The conductive coating layer preferably contains a carbon atom (carbon) and preferably contains a compound in which the proportion of the number of carbon atoms in the number of all atoms is 90% or more. A carbon atom has a high conductivity, and thus, for example, the resistance of the electrode can be decreased by using the active material coated with a carbon atom in the active material layer. In addition, the conductive coating layer may contain a graphene oxide and may contain a reduced graphene oxide. Graphene is excellent in terms of electric characteristics (for example, a high conductivity) and flexibility and has a high mechanical strength.

Graphene that is used in the conductive coating layer may be a single layer or multiple layers of two to 100 layers. A single layer of graphene means a sheet of a single atom layer of a carbon molecule having a π bond.

The reduced graphene oxide may include an oxygen atom. In a case in which the reduced graphene oxide includes an oxygen atom, the proportion of the oxygen atom is preferably 2% to 20% and more preferably 3% to 15% of the number of all atoms that constitute the graphene. The proportion of the oxygen atom can be measured and obtained by X-ray photoelectron spectroscopy (XPS).

In addition, the conductive coating layer may contain a metal compound. Here, examples of a metal atom include cobalt, aluminum, nickel, iron, manganese, titanium, zinc, lithium, carbon, and the like. As an example of the metal compound, the coating layer may have an oxide of the above-described metal, a fluoride of the above-described metal, or the like.

Meanwhile, the conductive coating layer may be formed of fine particles made of an oxide as described in JP2016-072071A.

The thickness of the conductive coating layer coating the active material is, for example, preferably 0.1 nm or more and 100 nm or less and more preferably 1 nm or more and 20 nm or less. The thickness of the conductive coating layer can be measured using, for example, a transmission electron microscope (TEM) or the like.

The conductive coating layer is preferably caused to coat the particle surfaces of the active material in a uniform film thickness, but is also permitted to coat the particle surfaces in an uneven film thickness as long as the action effect of the present invention can be obtained.

The content of carbon and/or the metal compound in the coated active material is preferably 0.01 mol % to 4.0 mol % and more preferably 0.1 mol % to 2.0 mol % from the viewpoint of favorable cycle characteristics.

A method for coating the active material with the conductive coating layer is not particularly limited, the active material coated with the conductive coating layer can be obtained by, for example, immersing the active material in an aqueous solution of 10% sucrose, drying the active material, and heating the active material in an oven at 600° C. for four hours. Even after immersion, the active material coated with the conductive coating layer can be obtained by, for example, coating the surface layer of the active material using a rolling flow coating device and then heating the surface layer in an oven.

The electrode layer material of the embodiment of the present invention satisfies Expression (1).

0.1≤Ec/Ic≤1,000 Expression (1)

In the expression, Ec represents an electron conductivity of the electrode layer material, and Ic represents an ion conductivity of the electrode layer material.

### (Method for Measuring Ion Conductivity and Electron Conductivity of Electrode Layer Material)

In the present invention, as the ion conductivity and the electron conductivity of the electrode layer material, values computed using any of the following two methods are employed with reference to Journal of power sources 316 (2016) 215 to 223.

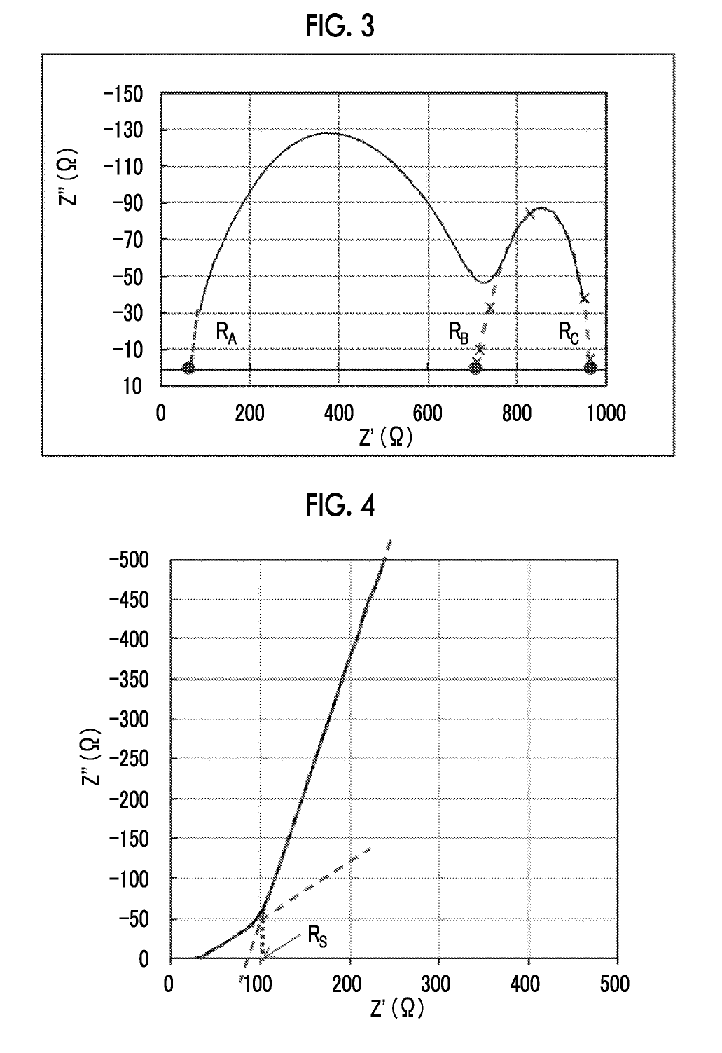

—Measurement Method (1) (Refer to FIG. 3)—

A titanium foil, the electrode layer material (which may be an electrode sheet for an all-solid state secondary battery disposed on a collector (the electrode layer material and the collector)), and a titanium foil are laminated in this order and pressurized at 180 MPa, thereby producing a molded article. This molded article is sandwiched by stainless steel electrode plates, thereby producing a cell for electrochemical measurement A.

The ion conduction resistance (R(ion)) and the electron conduction resistance (R(e)) of the electrode layer material are obtained by measuring the obtained cell for electrochemical measurement A using an alternating-current impedance method.

Specifically, R_{B} and R_{C} are scanned form the measured alternating-current impedance result and assigned to Expressions (I) and (II), whereby R(ion) and R(e) can be obtained. Furthermore, R(ion) and R(e) are assigned to Expressions (Ill) and (IV), whereby the ion conductivity and the electron conductivity of the electrode layer material can be obtained.

R_{B}=R(e)×R(ion)/(R(e)+R(ion)) Expression (1)

R_{c}=R(e) Expression (II)

Ion conductivity in electrode layer material=electrode layer material thickness/(R(ion)×electrode layer material area (height×width (radius×radius×π in the case of a disc-like pellet area))) Expression (III)

Electron conductivity in electrode layer material=electrode layer material thickness/(R(e)×electrode layer material area (height×width (radius×radius×π in the case of a disc-like pellet area))) Expression (IV)

—Measurement Method (2) (Refer to FIGS. 3 and 4)—

The cell for electrochemical measurement A is used, a low voltage of 50 μV is applied thereto, and the electron conductivity of the electrode layer material is obtained from the following expression at the time of a current value I(A) being stabilized (approximately four hours from the application of the voltage as a standard).

R(e)=0.05/I(A)

Electron conductivity of electrode layer material=electrode layer material thickness/(R(e)×electrode layer material area (height×width (radius×radius×π in the case of a disc-like pellet area)))

A titanium foil, the electrode layer material, a solid electrolyte layer, the electrode layer material, and a titanium foil are laminated in this order, thereby producing a molded article. This molded article is sandwiched by stainless steel electrode plates, thereby producing a cell for electrochemical measurement B.

The ion conductivity of the electrode is obtained from the following expression by measuring the obtained cell for electrochemical measurement B using an alternating-current impedance method.

Rs=⅓(R(ion)+R(e))

Ion conductivity of electrode layer material=electrode layer material thickness/(R(ion)×electrode layer material area (height×width (radius×radius×π in the case of a disc-like pellet area)))

The electrode layer material of the embodiment of the present invention is capable of suppressing material deterioration attributed to an electrochemical reaction. Therefore, it is considered that the battery characteristics can be more effectively improved by using the electrode layer material for a positive electrode that is considered to be more significantly affected by an electrochemical reaction, and thus the electrode layer material is preferably a positive electrode layer.

The electrode layer material of the embodiment of the present invention desirably causes an electrochemical reaction uniformly up to the inside of the active material and thus preferably satisfies Expression (2).

1≤Ec/Ic≤100 Expression (2)

In the electrode layer material of the embodiment of the present invention, in a case in which the ion conductivity and the electron conductivity are set to 1×10⁻⁵ or more, the current quantity at which a battery can be operated increases, and the battery performance tends to improve. The upper limits of the ion conductivity and the electron conductivity are not particularly limited; however, realistically 1(1 or less, and thus Ec preferably satisfies 1×10⁻⁵ S/cm≤Ec≤1×10⁻¹ S/cm, and Ic preferably satisfies 1×10⁻⁵ S/cm≤Ic≤1×10⁻² S/cm.

### (Conductive Auxiliary Agent (D))

The electrode layer material of the embodiment of the present invention preferably includes a conductive auxiliary agent.

The electrode layer material of the embodiment of the present invention more preferably includes at least two or more conductive auxiliary agents.

One of the conductive auxiliary agents that are used in the present invention has a carbon element and at least one metal element belonging to Group XII, XIII, or XIV of the periodic table, and the ratio of the major axis length to the minor axis length (aspect ratio) of a particle constituting the conductive auxiliary agent is preferably 10 or more.

In a case in which the conductive auxiliary agent that is used in the present invention has a carbon element and a metal element belonging to Group XII, XIII, or XIV of the periodic table, it becomes possible to satisfy both a sufficient electron conductivity and procurement aptitude such as the costs.

The upper limit of the aspect ratio of the particle constituting the conductive auxiliary agent having an aspect ratio of 10 or more which is used in the present invention is not particularly limited, but is preferably 10,000 or less and more preferably 5,000 or less. In a case in which the aspect ratio is set to the upper limit value or less, dispersion in the active material layer is easy, and it is possible to efficiently prevent a short-circuit caused by the conductive auxiliary agent penetrating the active material layer.

The aspect ratio of the particle constituting the conductive auxiliary agent that is used in the present invention can be measured with reference to a measurement method described in the section of examples.

The upper limit of the minor axis length of the particle constituting the conductive auxiliary agent having an aspect ratio of 10 or more which is used in the present invention is not particularly limited, but is preferably 10 μm or less, more preferably 8 μm or less, and particularly preferably 5 μm or less. On the other hand, the lower limit of the minor axis length of the particle constituting the conductive auxiliary agent having an aspect ratio of 10 or more which is used in the present invention is not particularly limited, but is preferably 1 nm or more, more preferably 3 nm or more, and particularly preferably 5 nm or more.

In addition, the upper limit of the average value of the minor axis lengths of the particles constituting the conductive auxiliary agent having an aspect ratio of 10 or more which is used in the present invention is not particularly limited, but is preferably 8 μm or less, more preferably 5 μm or less, and particularly preferably 3 μm or less. On the other hand, the lower limit of the average value of the minor axis lengths of the particles constituting the conductive auxiliary agent having an aspect ratio of 10 or more which is used in the present invention is not particularly limited, but is preferably 1 nm or more, more preferably 2 nm or more, and particularly preferably 3 nm or more.

Here, “the average value of the minor axis lengths of the particles constituting the conductive auxiliary agent” refers to the average value of the minor axis lengths of the conductive auxiliary agent excluding top and bottom 10% from the minimum lengths (minor axis lengths) of 50 particles constituting the conductive auxiliary agent which are computed using the measurement method described in the section of the examples.

It is preferable that one of the conductive auxiliary agents that are used in the present invention has a carbon element and at least one metal element belonging to Group XII, XIII, or XIV of the periodic table and the ratio of the aspect ratio is 3 or less.

In a case in which the conductive auxiliary agent having an aspect ratio of 10 or more and the conductive auxiliary agent having an aspect ratio of 3 or less are combined together, the conductive auxiliary agent having an aspect ratio of 3 or less connects the conductive auxiliary agent having an aspect ratio of 10 or more, the continuous connection of the electron conduction path between the active material and the conductive auxiliary agent becomes favorable, the electron conductivity in the electrode layer material increases, and the output characteristics of the all-solid state secondary battery can be improved.

The lower limit of the aspect ratio of the particle constituting the conductive auxiliary agent having an aspect ratio of 3 or less which is used in the present invention is not particularly limited, but is more preferably 1 or more.

The upper limit of the minor axis length of the particle constituting the conductive auxiliary agent having an aspect ratio of 3 or less which is used in the present invention is not particularly limited, but is preferably 50 μm or less, more preferably 40 μm or less, and particularly preferably 30 μm or less. On the other hand, the lower limit of the minor axis length of the particle constituting the conductive auxiliary agent having an aspect ratio of 3 or less which is used in the present invention is not particularly limited, but is preferably 5 μm or more, more preferably 10 μm or more, and particularly preferably 20 μm or more.

In addition, the upper limit of the average value of the minor axis lengths of the particles constituting the conductive auxiliary agent having an aspect ratio of 3 or less which is used in the present invention is not particularly limited, but is preferably 50 μm or less, more preferably 40 μm or less, and particularly preferably 30 μm or less. On the other hand, the lower limit of the average value of the minor axis lengths of the particles constituting the conductive auxiliary agent having an aspect ratio of 3 or less which is used in the present invention is not particularly limited, but is preferably 5 μm or more, more preferably 10 μm or more, and particularly preferably 20 μm or more.

Meanwhile, the shape of the particle constituting the conductive auxiliary agent is not particularly limited as long as the above-described characteristics are satisfied, but is preferably, for example, a needle shape, a tubular shape, a dumbbell shape, a disc shape, or an elliptical shape from the viewpoint of the prevention of peeling from a solid particle and the ensuring of the contact point with a solid particle.

### (Lithium Salt)

The electrode layer material of e embodiment f the present invention may contain a lithium salt.

The lithium salt is not particularly limited, and, for example, a lithium salt described in Paragraphs 0082 to 0085 of JP2015-088486A is preferred.

The content of the lithium salt is preferably 0 parts by mass or more and more preferably 5 parts by mass or more with respect to 100 parts by mass of the inorganic solid electrolyte. The upper limit is preferably 50 parts by mass or less and more preferably 20 parts by mass or less.

### (Production of Electrode Layer Material)

Hereinafter, an example of a method for producing the electrode layer material of the embodiment of the present invention will be described.

First, the inorganic solid electrolyte and the organic compound (for example, the binder) are dispersed in the presence of the dispersion medium and stirred, thereby preparing a solid electrolyte composition (slurry). The active material is added to and stirred in the solid electrolyte composition, thereby obtaining a composition for an electrode (slurry). Meanwhile, the composition for an electrode may be prepared by stirring the inorganic solid electrolyte, the organic compound, and the active material in the presence of the dispersion medium from the beginning.

The electron conductivity and the ion conductivity of the electrode layer material can be adjusted using the content of the inorganic solid electrolyte or the like that is contained in the composition for a positive electrode.

The stirring can be carried out by mixing the inorganic solid electrolyte, the organic compound, the active material, and the dispersion medium using a variety of mixers. The mixing device is not particularly limited, and examples thereof include a ball mill, a beads mill, a planetary mixer, a blade mixer, a roll mill, a kneader, and a disc mill. The mixing conditions are not particularly limited; however, in the case of using a ball mill, the above-described components are preferably mixed together at 150 to 700 rpm (rotation per minute) for one hour to 24 hours.

In the case of preparing a composition for an electrode containing random components such as a conductive auxiliary agent, the components may be added and mixed at the same time as a dispersion step of the inorganic solid electrolyte, the organic solvent, and the active material or may be separately added and mixed.

The electrode layer material of the embodiment of the present invention can be obtained by applying the composition for an electrode prepared above onto a base material using a method described below to form a film. The base material is not particularly limited as long as the base material is capable of supporting the electrode layer material, and examples thereof include sheet bodies (plate-like bodies) of materials, organic materials, inorganic materials, and the like which will be described in the section of the collector described below. Examples of the organic materials include a variety of polymers and the like, and specific examples thereof include polyethylene terephthalate, polypropylene, polyethylene, cellulose, and the like. Examples of the inorganic materials include glass, ceramic, and the like.

In the present invention, a sheet having a constitution in which an electrode layer is provided on a collector will be referred to as an electrode sheet for an all-solid state secondary battery (a positive electrode sheet for an all-solid state secondary battery or a negative electrode sheet for an all-solid state secondary battery) in some cases. The electrode sheet for an all-solid state secondary battery may have a different layer other than the collector and the electrode layer. Examples of the different layer include a protective layer, a solid electrolyte layer, and the like.

[All-Solid State Secondary Battery]

An all-solid state secondary battery of the embodiment of the present invention has a positive electrode, a negative electrode facing the positive electrode, and a solid electrolyte layer between the positive electrode and the negative electrode. The positive electrode has a positive electrode active material layer on a positive electrode collector. The negative electrode has a negative electrode active material layer on a negative electrode collector.

At least one layer of the negative electrode active material layer or the positive electrode active material layer is the electrode layer material o the embodiment of the present invention.

Hereinafter, a preferred embodiment of the present invention will be described with reference to FIG. 1, but the present invention is not limited thereto.

[Positive Electrode Active Material Layer, Solid Electrolyte Layer, and Negative Electrode Active Material Layer]

In the all-solid state secondary battery 10, any one of the positive electrode active material layer 4 or the negative electrode active material layer 2 is the electrode layer material of the embodiment of the present invention. The inorganic solid electrolyte and the organic compound that the positive electrode active material layer 4 and the negative electrode active material layer 2 contain may be identical to or different from each other. Meanwhile, for example, in a case in which the positive electrode active material layer 4 is the electrode layer material of the embodiment of the present invention, it is possible to use a negative electrode active material layer that is used in an ordinary all-solid state secondary battery as the negative electrode active material layer 2. In addition, the solid electrolyte layer 3 may be a solid electrolyte layer that is used in an ordinary all-solid state secondary battery, and examples thereof include a solid electrolyte layer formed using the solid electrolyte composition.

[Collector (Metal Foil)]

The positive electrode collector 5 and the negative electrode collector 1 are preferably an electron conductor.

In the present invention, there are cases in which any or both of the positive electrode collector and the negative electrode collector will be simply referred to as the collector.

As a material forming the positive electrode collector, aluminum, an aluminum alloy, stainless steel, nickel, titanium, or the like, and furthermore, a material obtained by treating the surface of aluminum or stainless steel with carbon, nickel, titanium, or silver (a material forming a thin film) is preferred, and, among these, aluminum and an aluminum alloy are more preferred.

As a material forming the negative electrode collector, aluminum, copper, a copper alloy, stainless steel, nickel, titanium, or the like, and furthermore, a material obtained by treating the surface of aluminum, copper, a copper alloy, or stainless steel with carbon, nickel, titanium, or silver is preferred, and aluminum, copper, a copper alloy, or stainless steel is more preferred.

Regarding the shape of the collector, generally, collectors having a film sheet-like shape are used, but it is also possible to use net-shaped collectors, punched collectors, molded articles of lath bodies, porous bodies, foaming bodies, or fiber groups, and the like.

The thickness of the collector is not particularly limited, but is preferably 1 to 500 μm. In addition, the surface of the collector is preferably provided with protrusions and recesses by means of a surface treatment.

In the present invention, a functional layer, member, or the like may be appropriately interposed or disposed between the respective layers of the negative electrode collector, the negative electrode active material layer, the solid electrolyte layer, the positive electrode active material layer, and the positive electrode collector or on the outside thereof. In addition, the respective layers may be composed of a single layer or multiple layers.

[Chassis]

It is possible to produce the basic structure of the all-solid state secondary battery by disposing the respective layers described above. Depending on the use, the basic structure may be directly used as an all-solid state secondary battery, but the basic structure may be used after being enclosed in an appropriate chassis in order to have a dry battery form. The chassis may be a metallic chassis or a resin (plastic) chassis. In a case in which a metallic chassis is used, examples thereof include an aluminum alloy chassis and a stainless-steel chassis. The metallic chassis is preferably classified into a positive electrode-side chassis and a negative electrode-side chassis and electrically connected to the positive electrode collector and the negative electrode collector respectively. The positive electrode-side chassis and the negative electrode-side chassis are preferably integrated by being joined together through a gasket for short circuit prevention.

[Manufacturing of All-Solid State Secondary Battery]

The all-solid state secondary battery can be manufactured using an ordinary method. Specifically, the all-solid state secondary battery can be manufactured by forming the respective layers described above using the solid electrolyte composition or the like. Hereinafter, the manufacturing method will be described in detail.

The all-solid state secondary battery of the embodiment of the present invention can be manufactured using a method including (through) a step of applying the solid electrolyte composition onto a metal foil which serves as a collector and forming a coated film (film manufacturing).

For example, a solid electrolyte composition containing a positive electrode active material is applied as a material for a positive electrode (a composition for a positive electrode) onto a metal foil which is a positive electrode collector so as to form a positive electrode active material layer, thereby producing a positive electrode sheet for an all-solid state secondary battery. Next, a solid electrolyte composition for forming a solid electrolyte layer is applied onto the positive electrode active material layer so as to form a solid electrolyte layer. Furthermore, a solid electrolyte composition containing negative electrode active material is applied as a material for a negative electrode (a composition for a negative electrode) onto the solid electrolyte layer so as to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can be produced by enclosing the all-solid state secondary battery in a chassis as necessary.

In addition, it also possible to manufacture an all-solid state secondary battery by carrying out the methods for forming the respective layers in a reverse order so as to form a negative electrode active material layer, a solid electrolyte layer, and a positive electrode active material layer on a negative electrode collector and overlaying a positive electrode collector thereon.

As another method, the following method can be exemplified. That is, a positive electrode sheet for an all-solid state secondary battery is produced as described above. In addition, a solid electrolyte composition containing a negative electrode active material is applied as a material for a negative electrode (a composition for a negative electrode) onto a metal foil which is a negative electrode collector so as to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer so that the solid electrolyte layer and the active material layer come into contact with each other. An all-solid state secondary battery can be manufactured as described above.

As still another method, the following method can be exemplified. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, a solid electrolyte composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated together so as to sandwich the solid electrolyte layer that has been peeled off from the base material. An all-solid state secondary battery can be manufactured as described above.

An all-solid state secondary battery can be manufactured by combining the above-described forming methods. For example, a positive electrode sheet for an all-solid state secondary battery, a negative electrode sheet fix an all-solid state secondary battery, and a solid electrolyte sheet for an all-solid state secondary battery (sheets obtained by applying the solid electrolyte composition not including the active material onto a base material to form a film) are produced respectively. Next, a solid electrolyte layer peeled off from a base material is laminated on the negative electrode sheet for an all-solid state secondary battery and is then attached to the positive electrode sheet for an all-solid state secondary battery, whereby an all-solid state secondary battery can be manufactured. In this method, it is also possible to laminate the solid electrolyte layer on the positive electrode sheet for an all-solid state secondary battery and attach the solid electrolyte layer to the negative electrode sheet for an all-solid state secondary battery.

Meanwhile, in the present specification, the positive electrode sheet for an all-solid state secondary battery, the negative electrode sheet for an all-solid state secondary battery, and/or the solid electrolyte sheet for an all-solid state secondary battery will be referred to as the sheet for an all-solid state secondary battery in some cases.

### (Formation of Individual Layers (Film Formation))

The method for applying the solid electrolyte composition is not particularly limited and can be appropriately selected. Examples thereof include coating (preferably wet-type coating), spray coating, spin coating, dip coating, slit coating, stripe coating, and bar coating.

At this time, the solid electrolyte composition may be dried after being applied or may be dried after being applied to multiple layers. The drying temperature is not particularly limited. The lower limit is preferably 30° C. or higher, more preferably 60° C. or higher, and still more preferably 80° C. or higher, and the upper limit is preferably 300° C. or lower, more preferably 250° C. or lower, and still more preferably 200° C. or lower, in a case in which the compositions are heated in the above-described temperature range, it is possible to remove the dispersion medium and form a solid state. In addition, the temperature is not excessively increased, and the respective members of the all-solid state secondary battery are not impaired, which is preferable. Therefore, in the all-solid state secondary battery, excellent total performance is exhibited, and it is possible to obtain a favorable binding property.

After the application of the solid electrolyte composition or the production of the all-solid state secondary battery, the respective layers or the all-solid state secondary battery is preferably pressurized. In addition, the respective layers are also preferably pressurized in a state of being laminated together. Examples of the pressurization method include a hydraulic cylinder pressing machine and the like. The welding pressure is not particularly limited, but is, generally, preferably in a range of 50 to 1,500 MPa.

In addition, the applied solid electrolyte composition may be heated at the same time as pressurization. The heating temperature is not particularly limited, but is generally in a range of 30° C. to 300° C. The respective layers or the all-solid state secondary battery can also be pressed at a temperature higher than the glass transition temperature of the inorganic solid electrolyte.

The pressurization may be carried out in a state in which the applied solvent or dispersion medium has been dried in advance or in a state in which the solvent or the dispersion medium remains.

Meanwhile, the respective compositions may be applied at the same time, and the application, the drying, and the pressing may be carried out simultaneously and/or sequentially. The respective compositions may be applied to separate base materials and then laminated by means of transfer.

The atmosphere during the pressurization is not particularly limited and may be any one of in the atmosphere, under the dried air (the dew point: −20° C. or lower), in an inert gas (for example, in an argon gas, in a helium gas, or in a nitrogen gas), and the like.

The pressing time may be a short time (for example, within several hours) at a high pressure or a long time (one day or longer) under the application of an intermediate pressure. In the case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure can be changed depending on the area or film thickness of the portion under pressure. In addition, it is also possible to change the same portion with a pressure that varies stepwise.

A pressing surface may be flat or roughened.

### (Initialization)

The all-solid state secondary battery manufactured as described above is preferably initialized after the manufacturing or before the use. The initialization is not particularly limited, and it is possible to initialize the all-solid state secondary battery by, for example, carrying out initial charging and discharging in a state in which the pressing pressure is increased and then releasing the pressure up to a pressure at which the all-solid state secondary battery is ordinarily used.

[Usages of All-Solid State Secondary Battery]

The all-solid state secondary battery of the embodiment of the present invention can be applied to a variety of usages. Application aspects are not particularly limited, and, in the case of being mounted in electronic devices, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, portable tape recorders, radios, backup power supplies, memory cards, and the like. Additionally, examples of consumer usages include automobiles (electric vehicles and the like), electric vehicles, motors, lighting equipment, toys, game devices, road conditioners, watches, strobes, cameras, medical devices (pacemakers, hearing aids, shoulder massage devices, and the like), and the like. Furthermore, the all-solid state secondary battery can be used for a variety of military usages and universe usages. In addition, the all-solid state secondary battery can also be combined with solar batteries.

According to the preferred embodiment of the present invention, individual application forms as described below are derived.
[1] All-solid state secondary batteries in which positive electrode active material layer and a negative electrode active material layer are the electrode layer material according to the embodiment of the present invention.
[2] Methods for manufacturing an all-solid state secondary battery in which a positive electrode active material layer is formed by applying a slurry including a conductive auxiliary agent and a sulfide-based inorganic solid electrolyte dispersed using a dispersion medium in a wet manner.
[3] Methods for manufacturing an all-solid state secondary battery in which a positive electrode active material layer is formed by applying a slurry including a lithium salt and a sulfide-based inorganic solid electrolyte dispersed using a dispersion medium in a wet manner.
[4] Electrode sheets for an all-solid state secondary battery obtained by applying a solid electrolyte composition containing an active material onto a metal foil to forma film.
[5] Methods for manufacturing an electrode sheet for an all-solid state secondary battery in which the solid electrolyte composition is applied onto a metal foil, thereby forming a film.

As described in the preferred embodiments [2] and [5], preferred methods for manufacturing the all-solid state secondary battery and the electrode sheet for an all-solid state secondary battery according to the embodiment of the present invention are all wet-type processes. Therefore, even inn a region in at least one layer of the positive electrode active material layer or the negative electrode active material layer in which the content of the inorganic solid electrolyte is as low as 10% by mass or less, the adhesiveness between the active material and the inorganic solid electrolyte, an efficient ion conduction path can be maintained, and it is possible to manufacture an all-solid state secondary battery having a high energy density (Wh/kg) and a high output density (W/kg) per battery mass.

All-solid state secondary batteries refer to secondary batteries having a positive electrode, a negative electrode, and an electrolyte which are all composed of solid. In other words, all-solid state secondary batteries are differentiated from electrolytic solution-type secondary batteries in which a carbonate-based solvent is used as an electrolyte. Among these, the present invention is assumed to be an inorganic all-solid state secondary battery. All-solid state secondary batteries are classified into organic (polymer) all-solid state secondary batteries in which a polymer compound such as polyethylene oxide is used as an electrolyte and inorganic all-solid state secondary batteries in which the Li—P—S-based glass, or the like is used. Meanwhile, the application of organic compounds to inorganic all-solid state secondary batteries is not inhibited, and organic compounds can also be applied as binders or additives of positive electrode active materials, negative electrode active materials, and inorganic solid electrolytes.

Inorganic solid electrolytes are differentiated from electrolytes in which the above-described polymer compound is used as an ion conductive medium (polymer electrolyte), and inorganic compounds serve as ion conductive media. Specific examples thereof include the Li—P—S-based glass and the like. Inorganic solid electrolytes do not emit positive ions (Li ions) and exhibit an ion transportation function. In contrast, there are cases in which materials serving as an ion supply source which is added to electrolytic solutions or solid electrolyte layers and emits positive ions (Li ions) are referred to as electrolytes; however, in the case of being differentiated from electrolytes as the ion transportation materials, the materials are referred to as “electrolyte salts” or “supporting electrolytes”. Examples of the electrolyte salts include LiTFSI.

In the present invention, “compositions” refer to mixtures obtained by uniformly mixing two or more components. Here, compositions may partially include agglomeration or uneven distribution as long as the compositions substantially maintain uniformity and exhibit desired effects.

### EXAMPLES

Hereinafter, the present invention will be described in more detail on the basis of examples. Meanwhile, the present invention is not interpreted to be limited thereto. “Parts” and “%” that represent compositions in the following examples are mass-based unless particularly otherwise described.

### <Synthesis Example of Sulfide-Based Inorganic Solid Electrolyte (Li—P—S-Based Glass)>

As a sulfide-based inorganic solid electrolyte, Li—P—S-based glass was synthesized with reference to a non-patent document of T. Ohtomo, A. Hayashi, M. Tatsumisago, Y. Tsuchida, S. HamGa, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

### (1) Synthesis of Li—P—S-Based Glass (A-1)

Specifically, in a glove box under an argon atmosphere (dew point: −70° C.), lithium sulfide (Li₂S, manufactured by Aldrich-Sigma, Co. LLC., Purity: >99.98%) (2.42 g) and diphosphorus pentasulfide (P₂S₅, manufactured by Aldrich-Sigma, Co. LLC., Purity: >99%) (3.90 g) were respectively weighed, injected into an agate mortar, and mixed together for five minutes using an agate muddler. The mixing ratio (Li₂S:P₂S₅) between Li₂S and P₂S₅ was set to 75:25 in terms of the molar ratio.

Zirconia beads having a diameter of 5 mm (66 g) were injected into a 45 mL zirconia container (manufactured by Fritsch Japan Co., Ltd.), the full amount of the mixture of lithium sulfide and diphosphorus pentasulfide was injected thereinto, and the container was sealed in an argon atmosphere. The container was set in a planetary ball mill P-7 (trade name, manufactured by Fritsch Japan Co., Ltd.) manufactured by Fritsch Japan Co., Ltd., mechanical milling was carried out at a temperature of 25° C. and a rotation speed of 510 rpm for 20 hours, thereby obtaining yellow powder (6.20 g) of Li—P—S-based glass (A-1). The ion conductivity of the Li—P—S-based glass (A-1) was 0.8×10⁻³ S/cm, and the volume-average particle diameter was 8.6 μm.

### (1) Synthesis of Li—P—S-Based Glass (A-2)

In a glove box under an argon atmosphere (dew point: −70° C.), lithium sulfide (Li₂S, manufactured by Aldrich-Sigma, Co. LLC., Purity: >99.98%) (1.54 g), diphosphorus pentasulfide (P₂S₅, manufactured by Aldrich-Sigma, Co. LLC., Purity: >99%) (1.47 g), and germanium disulfide (GeS₂, manufactured by Kojundo chemical Lab. Co., Ltd.) (0.91 g) were respectively weighed, injected into an agate mortar, and mixed together for five minutes using an agate muddler. Li₂S, P₂S₅, and GeS₂ were mixed together so that the molar ratio of Li:P:S:Ge reached 10:2:12:1.

Zirconia beads having a diameter of 5 mm (66 g) were injected into a 45 mL zirconia container (manufactured by Fritsch Japan Co., Ltd.), the full amount of the mixture of Li₂S, P₂S₅, and GeS₂ was injected thereinto, and the container was sealed in an argon atmosphere. The container was set in a planetary ball mill P-7 (trade name, manufactured by Fritsch Japan Co., Ltd.) manufactured by Fritsch Japan Co., Ltd., and mechanical milling was carried out at a temperature of 25° C. and a rotation speed of 510 rpm for 20 hours.

The obtained material was put into a silica pipe and sealed in a vacuum, and the silica pipe was fired in a firing furnace at 550° C. for six hours. The silica pipe was cooled to room temperature (25° C.), and then Li—P—S-based glass (A-2) was obtained. The ion conductivity of the obtained Li—P—S-based glass (A-2) was 4.0×10⁻³ S/cm, and the volume-average particle diameter was 10.2 μm.

### (Method for Computing Ion Conductivity of Sulfide-Based Inorganic Solid Electrolyte)

The sulfide-based inorganic solid electrolyte produced above (100 mg) was weighed, injected into a pressure molding device capable of molding a subject into a circular shape having a diameter of 12 mm, and pressurized at 360 MPa, thereby obtaining a sulfide-based inorganic solid electrolyte molded article having a diameter of 12 mm. This molded article was sandwiched by stainless steel electrode plates, thereby producing a cell for electrochemical measurement.

The ion conduction resistance (R(ion)) of an electrode layer material was obtained by measuring the obtained cell for electrochemical measurement using an alternating-current impedance method.

The ion conductivity of the sulfide-based inorganic solid electrolyte was obtained from the following expression.

Ion conductivity of sulfide-based inorganic solid electrolyte=thickness (cm) of sulfide-based inorganic solid electrolyte molded article/(R(ion)×sulfide-based inorganic solid electrolyte molded article area (radius×radius×π) (cm²))

### (Method for Computing Volume-Average Particle Diameter)

The volume-average particle diameter was computed using the above-described method.

### Example 1

### <Preparation Example of Solid Electrolyte Composition>

### (1) Preparation of Solid Electrolyte Composition (S-1)

One hundred and eighty zirconia beads having a diameter of 5 mm were injected into a 45 mL zirconia container (manufactured by Fritsch Japan Co., Ltd.), and the above-synthesized Li—P—S-based glass (A-1) (9.7 g), PVdF-HFP (a copolymer of vinylidene fluoride and hexafluoropropylene) (manufactured by Arkema K.K.) (0.3 g) as a binder, and a heptane/tetrahydrofuran solvent mixture (15 g) as a dispersion medium were injected thereinto. After that, this container was set in a planetary ball mill P-7 (trade name, manufactured by Fritsch Japan Co., Ltd.), and the components were continuously stirred at a temperature of 25° C. and a rotation speed of 300 rpm for two hours. A solid electrolyte composition (S-1) was prepared in the above-described manner.

### (2) Preparation of Solid Electrolyte Compositions S-2 to S-4, T-1, and T-2

Solid electrolyte compositions S-2 to S-4, T-1, and T-2 were prepared in the same manner as the solid electrolyte composition S-1 except for the fact that the compositions were changed as shown in Table 2.

TABLE 1

| Solid | | | Organic | |
|---|---|---|---|---|
| electrolyte | Inorganic solid electrolyte | % by | compound | % by |
| composition | (A) | mass | (B) | mass |
| S-1 | Li—P—S-based glass (A-1) | 97 | PVdF-HFP | 3 |
| S-2 | Li—P—S-based glass (A-2) | 97 | PVdF-HFP | 3 |
| S-3 | Li—P—S-based glass (A-1) | 100 | — | — |
| S-4 | Li—P—S-based glass (A-2) | 99.9 | Compound S | 0.01 |
| T-1 | Lithium sulfide | 97 | PVdF-HFP | 3 |
| T-2 | LLZ | 97 | PVdF-HFP | 3 |

### <Notes of Table>

As the examples of the organic compound (B) in Table 1, only solid components are shown.

LLZ: Li₇La₃Zr₂O₁₂ (manufactured by Toshima Manufacturing Co., Ltd.)

Compound S: The synthesis method and the chemical formula will be described below.

Dipentaerythritol (manufactured by Tokyo Chemical Indus Co., Ltd,) (11.4 g) was added to a three-neck flask and heated and dissolved at 220° C. under a nitrogen stream. Nonanoc Acid (manufactured by Tokyo Chemical Industry Co., Ltd.) (45 g) was added thereto and heated and stirred at 230° C. for five hours. Water generated as a byproduct during the heating and stirring was removed using a Dean-Stark apparatus. Next, the obtained viscous oil was cooled to 170° C., succinic anhydride (manufactured by Wako Pure Chemical Industries, Ltd.) (9 g) was added thereto, and the components were continuously heated and stirred at 170° C. for four hours. The obtained viscous oil was put on a TEFLON (registered trademark) bat and cooled to room temperature (25° C.), thereby obtaining a compound S (surface modifier) having the following structure in a slightly yellow solid form. Meanwhile, the mass average molecular weight was 700.

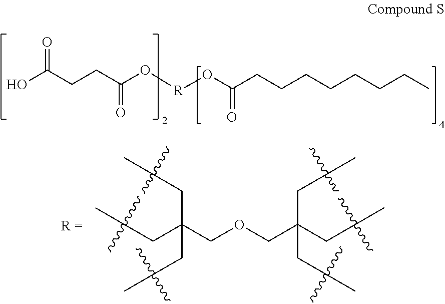

### <Preparation Example of Composition for Positive Electrode>

### (1) Preparation of Composition for Positive Electrode AS-1

Fifty zirconia beads having a diameter of 3 mm were injected into a 45 mL zirconia container (manufactured by Fritsch Japan Co., Ltd.), and the solid electrolyte composition S-1 prepared above (0.5 g) was added thereto. A positive electrode active material NMC (111) (4.37 g) and a conductive auxiliary agent A (acetylene black) (0.09 g) were added thereto, and then the container was set in a planetary ball mill P-7 (manufactured by Fritsch Japan Co., and the components were stirred at a temperature of 25° C. and a rotation speed of 100 rpm for 15 minutes, thereby preparing a composition for a positive electrode AS-1.

(2) Preparation of Compositions for Positive Electrode AS-2 to AS-10 and eAT-1 to eAT-6

Compositions for a positive electrode AS-2 to AS-10 and eAT-1 to eAT-6 were prepared in the same manner as the composition for a positive electrode AS-1 except for the tact that the compositions were changed as shown in Table 2. Meanwhile, in Table 2, the composition for a positive electrode is simply expressed as the composition.

In Table 2, the compositions of the compositions for a positive electrode are summarized. Meanwhile, the composition for a positive electrode AS-6 was prepared by adding the solid electrolyte composition S-2, furthermore, continuously stirring the components at a rotation speed of 370 rpm for 30 minutes, and then adding the positive electrode active material, the conductive auxiliary agent A, and the conductive auxiliary agent B in amounts shown in Table 2. Therefore, the volume-average particle diameter of the Li—P—S-based glass (A-2) in the composition for a positive electrode AS-6 was in a range of 10.2 μm to 1.1 μm.

TABLE 2

| | | | | Electron conductivity | | Conductive auxiliary | Conductive auxiliary |
|---|---|---|---|---|---|---|---|
| | Solid electrolyte | Mass | | of active material | Mass | agent A | agent B |
| Composition | composition | (g) | Active material | (S/cm) | (g) | (g) | (g) |
| AS-1 | S-1 | 0.5 | NMC (111) | 2 × 10⁻⁶ | 4.37 | 0.09 | — |
| AS-2 | S-1 | 1 | NCA | 4 × 10⁻² | 3.88 | — | — |
| AS-3 | S-2 | 1 | NMC (111) | 2 × 10⁻⁶ | 2.26 | 0.065 | — |
| AS-4 | S-2 | 1 | Carbon-coated | 1 × 10⁻² | 2.4 | 0.065 | — |
| | | | NMC (111) | | | | |
| AS-5 | S-2 | 1 | Carbon-coated | 1 × 10⁻² | 3.88 | 0.097 | 0.048 |
| | | | NMC (111) | | | | |
| AS-6 | S-2 | 1 | Carbon-coated | 1 × 10⁻² | 3.88 | 0.097 | 0.048 |
| | (particle diameter = | | NMC (111) | | | | |
| | 1.1 μm) | | | | | | |
| AS-7 | S-2 | 1 | LMO | 1 × 10⁻⁸ | 3.88 | — | — |
| AS-8 | S-1 | 1 | NCA | 4 × 10⁻² | 3.88 | 0.065 | 0.024 |
| AS-9 | S-3 | 1 | NMC (111) | 2 × 10⁻⁶ | 2.26 | 0.065 | 0.048 |
| AS-10 | S-4 | 1 | NMC (111) | 2 × 10⁻⁶ | 2.26 | 0.065 | 0.048 |
| eAT-1 | S-1 | 0.25 | NMC (111) | 2 × 10⁻⁶ | 4.61 | — | — |
| eAT-2 | S-1 | 0.25 | Carbon-coated | 1 × 10⁻² | 4.61 | — | — |
| | | | NMC (111) | | | | |
| eAT-3 | S-1 | 1 | Carbon-coated | 1 × 10⁻² | 3.88 | 0.24 | — |
| | | | NMC (111) | | | | |
| eAT-4 | Li—P—S-based glass | 0.97 | Carbon-coated | 1 × 10⁻² | 3.88 | 0.097 | 0.048 |
| | (A-1) | | NMC (111) | | | | |
| eAT-5 | S-2 | 1 | Carbon-coated | 1 × 10⁻² | 1 | — | — |
| | | | NMC (111) | | | | |
| eAT-6 | S-1 | 1 | Carbon-coated | 1 × 10⁻² | 5.5 | 0.097 | 0.048 |
| | | | NMC (111) | | | | |

### <Notes of Table>

NMC (111): Li(Ni_{0.33}Mn_{0.33}Co_{0.33})O₂

NCA: LiNi_{0.85}Co_{0.10}Al_{0.05}O₂ (lithium nickel cobalt aluminum oxide)

LMO: LiMn₂O₄

Carbon-coated NMC (111): NMC (111) was injected into a sucrose liquid obtained by dissolving 0.5% by mass of sucrose in a mixed solution of ethanol and water (7:3) and stirred at 25° C. for 30 minutes, and the mixed solution was removed using an evaporator. A mixture of sucrose and NMC (111) obtained in the above-described manner was injected into a muffle furnace in a nitrogen gas atmosphere and heated at 120° C. for two hours and then at 600° C. to form a carbon coat (thickness: 8 μm) on the surface, thereby obtaining the carbon-coated NMC.

Conductive auxiliary agent A: Acetylene black, volume-average particle diameter: 20 μm (aspect ratio: 1.1)

Conductive auxiliary agent B: VGCF-H (trade name) (manufactured by Showa Denko K. K.) (aspect ratio: 60)

eAT-4: The solid electrolyte composition was not used, and the Li—P—S-based glass (A-1) was used.

### <Preparation Example of Composition for Negative Electrode>

Preparation of Composition for Negative Electrode BS-1

Fifty zirconia beads having a diameter of 3 mm were injected into a 45 mL zirconia container (manufactured by Fritsch Japan Co., Ltd.), and the solid electrolyte composition S-1 prepared above (2.1 g) was added thereto. Graphite (3 g) was added thereto as a negative electrode active material, then, the container was set in a planetary ball mill P-7 (manufactured by Fritsch Japan Co., Ltd.), and the components were continuously stirred at a temperature of 25° C. and a rotation speed of 100 rpm for 15 minutes, thereby preparing a composition for a negative electrode BS-1 shown in Table 3.

In addition, compositions for a negative electrode BS-2, BS-3, and eBS-1 to eBS-4 were prepared in the same manner as the composition for a negative electrode BS-1 except for the fact that the compositions were changed as shown in Table 3. Meanwhile, in Table 3, the composition for a negative electrode is simply expressed as the composition.

TABLE 3

| | | | | Electron conductivity | | Conductive auxiliary | Conductive auxiliary |
|---|---|---|---|---|---|---|---|
| | Solid electrolyte | Mass | | of active material | Mass | agent A | agent B |
| Composition | composition | (g) | Active material | (S/cm) | (g) | (g) | (g) |
| BS-1 | S-1 | 2.1 | Graphite | 0.2 | 3 | — | — |
| BS-2 | S-1 | 2.1 | Hard carbon | 0.12 | 3 | — | — |
| BS-3 | S-2 | 2 | Graphite | 0.2 | 2 | 0.024 | 0.012 |
| eBS-1 | S-1 | 0.5 | Graphite | 0.2 | 7 | 0.012 | 0.012 |
| eBS-2 | Inorganic solid | 0.5 | Graphite | 0.2 | 2 | 0.012 | 0.012 |
| | electrolyte A | | | | | | |
| eBS-3 | S-2 | 0.7 | Hard carbon | 0.12 | 0.3 | — | — |
| eBS-4 | S-1 | 2.1 | Graphite | 0.2 | 2.1 | 0.012 | — |

### <Notes of Table>

Graphite: Volume-average particle diameter: 15 μm

Conductive auxiliary agent A: Identical to the above-described conductive auxiliary agent A

Conductive auxiliary agent B: Identical to the above-described conductive auxiliary agent B

eBS-2: The solid electrolyte composition was not used, and the inorganic solid electrolyte A (the Li—P—S-based glass (A-1)) was used.

### (Method for Computing Electron Conductivity of Active Material)

The active material (100 mg) was weighed, injected into a jig having a polyethylene terephthalate (PET) pipe as a mold for molding in a pressure molding device capable of molding a subject into a circular shape having a diameter of 12 mm, and pressurized at 360 MPa, thereby obtaining an active material molded article having a diameter of 12 mm. The top and the bottom of the pressure molding device were connected to an electrochemical measurement analyzer (trade name: a potentiostate 1470 and a frequency response analyzer 1255B, manufactured by Solartron Analytical), a voltage of 50 mV was applied to the pressure molding device, and a current value after four hours was obtained.

The electron conduction resistance of the active material was obtained from this current value and the voltage value, and the electron conduction resistance was computed from the thickness of the active material molded article and the area of the molded article.

Active material electron conductivity=thickness (cm) of active material molded article/(active material electron conduction resistance (Ω)×active material molded article area (radius×radius×π) (cm²))

—Method for Measuring Aspect Ratio of Particle Constituting Conductive Auxiliary Agent—

The aspect ratio of the particle constituting the conductive auxiliary agent was computed in the following manner by image-processing an electron micrograph.

SEM images of three random views captured at a magnification of 1,000 to 3,000 times using a scanning electron microscope (SEM) (XL30 (trade name) manufactured by Koninklijke Philips N. V) were converted to bitmap (BMP) files, images of 50 conductive auxiliary agent particles were scanned using “Azokun” which is an integrated application of IP-1000PC (trade name) manufactured by Asahi Kasei Engineering Corporation, the maximum values and the minimum values of the lengths of the respective particles were scanned in a state in which the particles were visible in the images without being overlapped, and the aspect ratio was computed in the following order.

Among the maximum lengths (major axis lengths) of the 50 particles, the average value (A) of 40 particles excluding the five largest particles and the five smallest particles was obtained. Next, among the minimum lengths (minor axis lengths) of the 50 particles, the average value (B) of 40 particles excluding the five largest particles and the five smallest particles was obtained. The average value (A) was divided by the average value (B), thereby computing the aspect ratio.

### <Production Example of Positive Electrode Sheet for All-Solid State Secondary Battery>

The composition for a positive electrode AS-1 prepared above was applied onto a 20 μm-thick aluminum foil (collector) using an applicator (trade name: SA-201 Baker type applicator, manufactured by Tester Sangyo Co., Ltd.), heated at 80° C. for one hour, and then further heated at 110° C. for one hour, thereby drying the composition for a positive electrode. After that, the dried composition for a positive electrode was heated (at 120° C.) and pressurized (at a pressure of 180 MPa for one minute) using a heat pressing machine, thereby producing a positive electrode sheet for an all-solid state secondary battery having a laminate structure of a positive electrode active material layer and the aluminum foil. The thickness of the positive electrode active material layer was 90 μm.

### <Production Example of All-Solid State Secondary Battery>

### (1) Production of All-Solid State Secondary Battery No. 101

### (Production of All-Solid State Secondary Battery Sheet)

The solid electrolyte composition S-1 prepared above was applied onto the positive electrode active material layer of the positive electrode sheet for an all-solid state secondary battery obtained above using the Baker type applicator, heated at 80° C. for one hour, and then further heated at 100° C. for one hour, thereby forming a 100 μm-thick solid electrolyte layer.

Next, the composition for a negative electrode BS-1 prepared above was applied onto the obtained solid electrolyte layer using the Baker type applicator, heated at 80° C. for one hour, and then further heated at 110° C. for one hour, thereby forming a 100 μm-thick negative electrode active material layer. A 20 μm-thick copper foil was overlaid on the negative electrode active material layer and heated at 120° C. and pressurized (at 600 MPa for one minute) using a heat pressing machine, thereby producing an all-solid state secondary battery sheet No. 101 shown in Table 1.

### (Production of All-Solid State Secondary Battery)

A disc-shaped piece having a diameter of 14.5 mm was cut out from the all-solid state secondary battery sheet obtained above. The all-solid state secondary battery sheet having a diameter of 14.5 mm cut to a diameter of 14.5 mm was put into a 2032-type stainless steel coin case 11 illustrated in FIG. 2 into which a spacer and a washer (both are not illustrated in FIG. 2) were combined, and the coin case 11 was swaged, thereby producing all-solid state secondary batteries No. 101 having a layer constitution illustrated in FIG. 1.

(2) Production of All-Solid State Secondary Batteries Nos. 102 to 110 and e101 to e106

All-solid state secondary batteries Nos. 102 to 110 and e101 to e106 were produced in the same manner as the all-solid state secondary battery Test No. 101 except for the fact that the composition was changed as shown in Table 4.

Meanwhile, the all-solid state secondary battery No. 109 was produced so that the content of THF reached as shown in Table 4.

In Table 4, the compositions of the all-solid state secondary batteries are summarized.

Here, the all-solid state secondary batteries Test Nos. 101 to 110 are the all-solid state secondary battery of the embodiment of the present invention, and the all-solid state secondary batteries Test Nos. e101 to e106 are the comparative all-solid state secondary batteries.

The ion conductivity Ic and the electron conductivity Ec of the positive electrode active material layers and the negative electrode active material layers of the all-solid state secondary batteries produced above were obtained using the measurement method (2). The results are shown in Table 4.

### <Testing>

On the all-solid state secondary batteries produced above, the following three tests were carried out. Hereinafter, testing methods will be described. In addition, the results are summarized in Table 4.

—4.2 V Cycle Test—

Using the all-solid state secondary batteries produced above, charging and discharging of 4,2 V to 3.0 V were repeated four times in an environment of 30° C. under conditions of a charging current value of 0.35 mA and a discharging current value of 0.7 mA.

After that, as a cycle test, a test of repeating charging and discharging of 4.2 V to 3.0 V in an environment of 30° C. under a condition of a charging and discharging current value of 0.7 mA was carried out.

The discharge capacity at the first cycle and the discharge capacity at the 100^{th} cycle were measured. The discharge capacity retentions (%) computed using the following expression are shown in Table 4.

Discharge capacity retentions (%)=discharge capacity at 100^{th} cycle/discharge capacity at 1^{st} cycle×100

—4.2 V High-Rate Cycle Test—

Using the all-solid state secondary batteries produced above, charging and discharging of 4.2 V to 3.0 V were repeated four times in an environment of 30° C. under conditions of a charging current value of 0.35 mA and a discharging current value of 0.7 mA. After that, as a cycle test, a test of repeating charging and discharging of 4.2 V to 3.0 V in an environment of 30° C. under a condition of a charging and discharging current value of 7 mA was carried out 100 cycles. Hereinafter, the evaluation standards will be described.

### <Evaluation Standards>

A: Out of ten all-solid state secondary batteries, nine or ten batteries were charged and discharged without any abnormality.

B: Out of ten all-solid state secondary batteries, seven or eight batteries were charged and discharged without any abnormality.

C: Out of ten all-solid state secondary batteries, five or six batteries were charged and discharged without any abnormality.

D: Out of ten all-solid state secondary batteries, three or four batteries were charged and discharged without any abnormality.

E: Out of ten all-solid state secondary batteries, up to two batteries were charged and discharged without any abnormality.

“Abnormality” refers to a case in which, in a region in which the battery voltage between 3.5 V and 4.2 V is shown during charging, a battery voltage drop of 0.05 V/sec or more is observed during charging or the open-circuit voltage after the end of discharging exhibits 2 V or less.

—Storage Characteristics Evaluation—

Using the all-solid state secondary batteries produced above, charging and discharging of 4.2 V to 3.0 V were repeated four times in an environment of 30° C. under conditions of a charging current value of 0.35 mA and a discharging current value of 0.7 mA. After that, a test of repeating charging and discharging of 4.2 V to 3.0 V in an environment of 30° C. under a condition of a charging and discharging current value of 0.7 mA was carried out five cycles. After that, the all-solid state secondary batteries were charged up to 4.2 V in an environment of 30° C. under a condition of a charging current value of 0.35 mA, discharged up to 4.1 V under a condition of a discharging current value of 0.7 mA, then, removed, and left to stand in a constant-temper tank (30° C.) for one week.

After one week, the all-solid state secondary batteries were discharged up to 3.0 V in an environment of 30° C. under a condition of a discharging current value of 0.7 mA, charged and discharged between 4.2 V to 3.0 V under a condition of a charging current value of 0.35 mA and a discharging current value of 0.7 mA, and the discharge capacity value at that time was considered as the discharge capacity after storage.

The deterioration percentage during storage T (%) computed using the following expression was evaluated using the following standards. The results are shown in the column of the storage characteristics of Table 4.

Deterioration percentage during storage (%)=(discharge capacity value before storage-discharge capacity value after storage)/discharge capacity value before storage×100

### <Evaluation Standards>

A: 0≤T≤15

B: 15<T≤35

C: 35<T≤50

D: 50<T≤75

E: 75<T≤100

TABLE 4

| | Positive | | | | | | | Negative | |
|---|---|---|---|---|---|---|---|---|---|
| | electrode | Content | | | | | | electrode | Content |
| | active | (solid | Content | | | | Solid | active | (solid |
| | material | component) | (solvent) | Ec | Ic | | electrolyte | material | component) |
| No. | layer | (% by mass) | (% by mass) | (S/cm) | (S/cm) | Ec/Ic | layer | layer | (% by mass) |
| 101 | AS-1 | 0.3 | 0.001 | 1.20 × 10⁻³ | 6.00 × 10⁻⁶ | 200 | S-1 | BS-1 | 1.24 |
| 102 | AS-2 | 0.6 | 0.0004 | 8.00 × 10⁻¹ | 9.70 × 10⁻⁶ | 82 | S-1 | BS-1 | 1.24 |
| 103 | AS-3 | 0.9 | 0.0002 | 1.40 × 10⁻³ | 5.00 × 10⁻⁵ | 28 | S-1 | BS-2 | 1.24 |
| 104 | AS-4 | 0.9 | 0.0001 | 4.00 × 10⁻³ | 6.00 × 10⁻⁵ | 67 | S-1 | BS-3 | 1.49 |
| 105 | AS-5 | 0.6 | 0.0003 | 7.00 × 10⁻³ | 1.10 × 10⁻⁴ | 63.6 | S-2 | BS-1 | 1.24 |
| 106 | AS-6 | 0.6 | — | 6.50 × 10⁻³ | 1.20 × 10⁻⁴ | 54.2 | S-2 | BS-1 | 1.24 |
| 107 | AS-7 | 0.6 | 0.0003 | 7.20 × 10⁻⁶ | 9.50 × 10⁻⁵ | 0.1 | S-2 | BS-1 | 1.24 |
| 108 | AS-8 | 0.6 | 0.0006 | 4.00 × 10⁻³ | 4.20 × 10⁻⁶ | 952 | S-1 | BS-1 | 1.24 |
| 109 | AS-9 | — | 0.03 | 2.60 × 10⁻³ | 5.20 × 10⁻⁵ | 50 | S-2 | BS-1 | 1.24 |
| 110 | AS-10 | 0.003 | 0.0008 | 3.00 × 10⁻³ | 4.90 × 10⁻⁵ | 61 | S-2 | BS-1 | 1.24 |
| e101 | eAT-1 | 0.2 | 0.001 | 1.50 × 10⁻³ | 3.00 × 10⁻⁷ | 5000 | S-1 | eBS-1 | 0.59 |
| e102 | eAT-2 | 0.2 | 0.0006 | 1.40 × 10⁻³ | 8.00 × 10⁻⁸ | 17500 | S-1 | eBS-1 | 0.59 |
| e103 | eAT-3 | 0.6 | 0.0008 | 2.50 × 10⁻² | 1.20 × 10⁻⁶ | 20833 | S-1 | eBS-1 | 0.59 |
| e104 | eAT-4 | — | — | 1.40 × 10⁻³ | 8.60 × 10⁻⁶ | 163 | S-1 | eBS-2 | — |
| e105 | eAI-5 | 1.5 | 0.0007 | 6.40 × 10⁻⁵ | 8.00 × 10⁻³ | 0.01 | S-1 | eBS-3 | 2.1 |
| e106 | eAT-6 | 0.5 | 0.0908 | 1.01 × 10⁻² | 9.10 × 10⁻⁶ | 1110 | S-1 | eBS-4 | 1.5 |

| | | | | | Discharge | | |
|---|---|---|---|---|---|---|---|
| | Content | | | | capacity | High-rate | |
| | (solvent) | | | | retention | cycle | Storage |
| No. | (% by mass) | Ec | Ic | Ec/Ic | (%) | characteristics | characteristics |
| 101 | 0.002 | 2.00 × 10⁻² | 6.00 × 10⁻⁵ | 333 | 88 | B | C |
| 102 | 0.003 | 2.00 × 10⁻² | 6.00 × 10⁻⁵ | 333 | 85 | B | B |
| 103 | 0.006 | 1.20 × 10⁻² | 7.10 × 10⁻⁵ | 169 | 78 | B | A |
| 104 | 0.006 | 2.80 × 10⁻² | 3.12 × 10⁻⁵ | 90 | 86 | A | A |
| 105 | 0.002 | 2.00 × 10⁻² | 6.00 × 10⁻⁵ | 333 | 89 | A | A |
| 106 | 0.001 | 2.00 × 10⁻² | 6.00 × 10⁻⁵ | 333 | 92 | A | A |
| 107 | 0.003 | 2.00 × 10⁻² | 6.00 × 10⁻⁵ | 333 | 61 | C | B |
| 108 | 0.002 | 2.00 × 10⁻² | 6.00 × 10⁻⁵ | 333 | 75 | B | C |
| 109 | 0.002 | 2.00 × 10⁻² | 6.00 × 10⁻⁵ | 333 | 81 | B | A |
| 110 | 0.003 | 2.00 × 10⁻² | 6.00 × 10⁻⁵ | 333 | 85 | B | A |
| e101 | 0.005 | 1.10 × 10⁻¹ | 6.80 × 10⁻⁶ | 16176 | 35 | E | A |
| e102 | 0.002 | 1.10 × 10⁻¹ | 6.80 × 10⁻⁶ | 16176 | 10 | E | A |
| e103 | 0.0001 | 1.10 × 10⁻¹ | 6.80 × 10⁻⁶ | 16176 | 5 | E | E |
| e104 | — | 8.01 × 10⁻¹ | 7.10 × 10⁻⁶ | 11268 | 35 | E | E |
| e105 | 0.0004 | 2.10 × 10⁻⁵ | 3.20 × 10⁻³ | 0.01 | 40 | E | D |
| e106 | 0.002 | 5.10 × 10⁻² | 4.30 × 10⁻⁵ | 1186 | 51 | B | D |

### <Notes of Table>

Content (solid component): The content of the organic compound (B) (solid component) in the active material layer

Content (solvent): The content of the organic compound (B) (dispersion medium left without being evaporated or volatilized) in the active material layer

The content of the solvent was measured using the above-described method.

As is clear from Table 4, in all of the all-solid state secondary batteries Nos, e101 to e106 which failed to satisfy the relationship between the electron conductivity and the ion conductivity regulated by the present invention, the discharge capacity retentions were low, and the high-rate cycle characteristics or the storage characteristics deteriorated.

Meanwhile, from the result of No. e104, it is found that, in the all-solid state secondary battery produced using the electrode layer material which had Ec/Ic satisfying the regulation of the present invention but did not contain the organic compound, the discharge capacity retentions and the high-rate cycle characteristics deteriorated. This is considered to be because, in the composition for an electrode, the inorganic solid electrolyte, the active material, and the conductive auxiliary agent were favorable dispersed due to the organic compound, and thus, in the electrode layer, the solid particles thereof were uniformly distributed, it became possible to cause an electrochemical reaction uniformly up to the inside of the active material, and it became difficult for a s reaction of lithium dendrite or the like to be caused.

In contrast, the all-solid state secondary battery of the embodiment of the present invention was excellent in terms of the discharge capacity retention, the high-rate cycle characteristics, and the storage characteristics.

The present invention has been described together with the embodiment: however, unless particularly specified, the present inventors do not intend to limit the present invention to any detailed portion of the description and consider that the present invention is supposed to be broadly interpreted within the concept and scope of the present invention described in the claims.

1: negative electrode collector

2: negative electrode active material layer

3: solid electrolyte layer

4: positive electrode active material layer

5: positive electrode collector

6: operation portion

10: all-solid state secondary battery

11: 2032-type coin case

12: all-solid state secondary battery sheet

13: all-solid state secondary battery

What is claimed is:

1. An electrode layer material comprising:
a sulfide-based inorganic solid electrolyte having conductivity of an ion of a metal belonging to Group I or II of a periodic table;
an organic compound (B); and
a positive electrode active material (C) coated with a conductive coating layer containing carbon,
wherein Expression (1) is satisfied,
0.1≤Ec/Ic≤1,000 Expression (1)
in the expression, Ec represents an electron conductivity of the electrode layer material, and Ic represents an ion conductivity of the electrode layer material.

2. The electrode layer material according, to claim 1,
wherein the organic compound (B) is a binder and/or a surface modifier.

3. The electrode layer material according to claim 2,
wherein a content of the binder and/or the surface modifier is 0.001% by mass or more and 10% by mass or less.

4. The electrode layer material according, to claim 1,
wherein the organic compound (B) is a dispersion medium.

5. The electrode layer material according to claim 4,
wherein a content of the dispersion medium is 0.5% by mass or less.

6. The electrode layer material according to claim 1,
wherein Expression (2) is satisfied,
1≤Ec/Ic≤100 Expression (2).

7. The electrode layer material according to claim 1,
wherein Ec satisfies 1×10⁻⁵ S/cm≤Ec≤1×10⁻¹ S/cm, and Ic satisfies 1×10⁻⁵ S/cm≤IC≤1×10⁻² S/cm.

8. The electrode layer material according to claim 1,
wherein an electron conductivity of the active material (C) is 1×10⁻⁷ S/cm or more and 1×10⁻¹ S/cm or less.

9. The electrode layer material according to claim 1,
wherein the conductive coating layer contains a metal oxide.

10. The electrode layer material according to claim 1, further comprising:
a conductive auxiliary agent (D).

11. The electrode layer material according to claim 10,
wherein the conductive auxiliary agent (D) includes a conductive auxiliary agent having an aspect ratio of 10 or more and a conductive auxiliary agent having an aspect ratio of 3 or less.

12. The electrode layer material according to claim 1,
wherein an ion conductivity of the sulfide-based inorganic solid electrolyte (A) is 1×10⁻³ S/cm or more.

13. An electrode sheet for an all-solid state secondary battery comprising:
the electrode layer material according to claim 1 on a metal foil.

14. An all-solid state secondary battery comprising:
a positive electrode active material layer;
a negative electrode active material layer; and
an inorganic solid electrolyte layer,
wherein the positive electrode active material layer is formed of the electrode layer material according to claim 1.

15. A method for manufacturing the electrode sheet for an all-solid state secondary battery according to claim 13, the method comprising:
a step of applying a solid electrolyte composition including a sulfide-based inorganic solid electrolyte (A) having conductivity of an ion of a metal belonging to Group I or II of a periodic table, an organic compound (B), and a positive electrode active material (C) coated with a conductive coating layer containing carbon.

16. A method for manufacturing an all-solid state secondary battery comprising:
a step of applying a solid electrolyte composition including a sulfide-based inorganic solid electrolyte (A) having conductivity of an ion of a metal belonging to Group I or II of a periodic table, an organic compound (B), and a positive electrode active material (C) coated with a conductive coating layer containing carbon thereby to manufacture an all-solid state secondary battery having the electrode sheet for an all-solid state secondary battery according to claim 15.
